(19) United States
(12) Patent Application Publication
(10) Pub. No.: US 2018/0263223 A1
(43) Pub. Date: Sep. 20, 2018

(54) SAME-FISH IDENTIFICATION DEVICE, FISH COUNTING DEVICE, PORTABLE TERMINAL FOR COUNTING FISH, SAME-FISH IDENTIFICATION METHOD, FISH COUNTING METHOD, FISH COUNT PREDICTION DEVICE, FISH COUNT PREDICTION METHOD, SAME-FISH IDENTIFICATION SYSTEM, FISH COUNTING SYSTEM, AND FISH COUNT PREDICTION SYSTEM

(71) Applicant: NEC Solution Innovators, Ltd., Koto-ku, Tokyo (JP)

(72) Inventors: Takayuki KODAIRA, Tokyo (JP); Masato TAGUCHI, Tokyo (JP); Takako NAKATANI, Tokyo (JP); Jou AKITOMI, Tokyo (JP)

(73) Assignee: NEC Solution Innovators, Ltd., Koto-ku, Tokyo (JP)

(21) Appl. No.: 15/534,656

(22) PCT Filed: Oct. 22, 2015
(86) PCT No.: PCT/JP2015/079881

§ 371 Date: Jun. 9, 2017

(30) Foreign Application Priority Data
Mar. 9, 2015 (JP) 2015-046118

(51) Int. Cl. A01K 61/95; G06T 7/73; G06T 7/90; G06K 9/00; G06K 9/03; G06T 7/13

(52) U.S. Cl. CPC A01K 61/95; G06T 7/74; G06T 7/90; G06T 2207/20224; G06K 9/03; G06T 7/13; G06T 2207/30242; G06K 9/00369

(57) ABSTRACT

The present invention provides a same fish easy identification device, a fish counting device, a mobile terminal for counting fish, a same fish identification method, a fish counting method, a fish count prediction device, a fish count prediction method, a same fish identification system, a fish counting system, and a fish count prediction system. The same fish identification device of the present invention includes: a measurement image acquisition unit 11; a fish position information acquisition unit 131; a predicted fish position information acquisition unit 132; and a same fish identification unit 133. The measurement image acquisition unit 11 acquires, over time, n measurement images of a region to be measured in a passage region where a fluid containing fish passes through. The fish position information acquisition unit 131 acquires fish position information in the n measurement images. The predicted fish position information acquisition unit 132 selects a selected image(s) from the measurement images acquired prior to a (m−1)th measurement image among the n measurement images and acquires predicted fish position information (PIₘ) in the m-th measurement image on the basis of the fish position information in the selected image. On the basis of the fish position information (Iₘ) in the m-th measurement image and the corresponding predicted fish position information (PIₘ), the same fish identification unit 133 identifies the fish in the m-th measurement image as the same fish as in the selected image when the fish position information (Iₘ) matches with the predicted fish position information (PIₘ) and identifies the fish in the m-th measurement image as not being the same fish as in the selected image when the fish position information (Iₘ) does not match with the predicted fish position information (PIₘ).

### TECHNICAL FIELD

The present invention relates to a same fish identification device, a fish counting device, a portable terminal for counting fish, a same fish identification method, a fish counting method, a fish count prediction device, a fish count prediction method, a same fish identification system, a fish counting system, and a fish count prediction system.

### BACKGROUND ART

For example, in aquaculture of fish, transferred fish are required to be counted. The fish are counted by visual check or manually, and the counting requires effort.

To solve this problem, the Patent Document 1 discloses a device in which a liquid containing fish is caused to flow from an upper side of an inclined channel that includes a counting portion, and fish that passed through the counting portion are counted. However, the device of the Patent Document 1 is expensive and involves costs.

### PRIOR ART DOCUMENTS

### Patent Document

Patent Document 1: WO 2013/080351

### SUMMARY OF INVENTION

### Problem to be Solved by the Invention

Hence, the present invention provides a same fish easy identification device, a fish counting device, a mobile terminal for counting fish, a same fish identification method, a fish counting method, a fish count prediction device, a fish count prediction method, a same fish identification system, a fish counting system, and a fish count prediction system.

### Means for Solving Problem

The present invention provides a same fish identification device including: a measurement image acquisition unit; a fish position information acquisition unit; a predicted fish position information acquisition unit; and a same fish identification unit, wherein the measurement image acquisition unit acquires, over time, n measurement images of a region to be measured in a passage region where a fluid containing at least one fish passes through, the fish position information acquisition unit acquires fish position information in the n measurement images, the predicted fish position information acquisition unit selects at least one selected image from the measurement images acquired prior to a (m−1)th measurement image among the n measurement images and acquires predicted fish position information (PIₘ) in the m-th measurement image on the basis of the fish position information in the at least one selected image, and on the basis of the fish position information (Iₘ) in the m-th measurement image and the corresponding predicted fish position information (PIₘ), the same fish identification unit identifies the at least one fish in the m-th measurement image as the same fish as in the at least one selected image when the fish position information (Iₘ) matches with the predicted fish position information (PIₘ) and identifies the at least one fish in the m-th measurement image as not being the same fish as in the at least one selected image when the fish position information (Iₘ) does not match with the predicted fish position information (PIₘ).

The present invention provides a fish counting device including: the same fish identification device of the present invention, including a measurement image acquisition unit, a fish position information acquisition unit, a predicted fish position information acquisition unit, and a same fish identification unit; and a fish counting unit, wherein the fish counting unit counts the at least one fish on the basis of same fish position information on the fish identified as the same fish by the same fish identification device, to obtain a fish count.

The present invention provides a mobile terminal for counting fish, including: the fish counting device of the present invention including a same fish identification device and a fish counting unit; and a display unit, wherein the display unit displays a fish count obtained by the fish counting device.

The present invention provides a same fish identification method for identifying the same fish, including: a measurement image acquisition step; a fish position information acquisition step; a predicted fish position information acquisition step; and a same fish identification step, wherein in the measurement image acquisition step, n measurement images of a region to be measured in a passage region where a fluid containing at least one fish passes through are acquired over time, in the fish position information acquisition step, fish position information in the n measurement images is acquired, in the predicted fish position information acquisition step, at least one selected image is selected from the measurement images acquired prior to the (m−1)th measurement image among the n measurement images, and predicted fish position information (PIₘ) in the m-th measurement image is acquired on the basis of the fish position information in the at least one selected image, and in the same fish identification step, on the basis of the fish position information (Iₘ) in the m-th measurement image and the corresponding predicted fish position information (PIₘ), the at least one fish in the m-th measurement image is identified as the same fish as in the at least one selected image when the fish position information (Iₘ) matches with the predicted fish position information (PIₘ) and is identified as not being the same fish as in the at least one selected image when the fish position information (Iₘ) does not match with the predicted fish position information (PIₘ).

The present invention provides a fish counting method, including: the same fish identification method of the present invention, including a measurement image acquisition step, a fish position information acquisition step, a predicted fish position information acquisition step, and a same fish identification step; and a fish counting step, wherein in the fish counting step, the at least one fish is counted on the basis of same fish position information on the fish identified as the same fish by the same fish identification method, to obtain a fish count.

The present invention provides a fish count prediction device including: the fish counting device of the present invention, including a same fish identification device and a fish counting unit; and a fish count prediction unit, wherein the fish count prediction unit predicts a fish count of the at least one fish passed through the passage region on the basis of the fish count obtained from k measurement images within time set in advance by the fish counting device, the time set in advance, and total time required for the fluid containing the at least one fish to pass through the passage region.

The present invention provides a fish count prediction method including: the fish counting method of the present invention, including a same fish identification method and a fish counting step; and a fish count prediction step, wherein in the fish count perdition step, on the basis of the fish count obtained from k measurement images within time set in advance by the fish counting device, the time set in advance, and total time required for the fluid containing at least one fish to pass through the passage region, a fish count of the at least one fish passed through the passage region is predicted.

The present invention provides a program configured to execute the same fish identification method of the present invention, the fish counting method of the present invention, or the fish count prediction method of the present invention.

The present invention provides a computer-readable recording medium including the program of the present invention.

The present invention provides a same fish identification system including: a terminal; and a server, wherein the terminal and the server are connectable to each other via a communication network outside the same fish identification system, the terminal includes: a measurement image acquisition unit; and an output unit, wherein the measurement image acquisition unit acquires, over time, n measurement images of a region to be measured in the passage region where a fluid containing at least one fish passes through, and the output unit output an identification of the same fish or not, the server includes: a fish position information acquisition unit; a predicted fish position information acquisition unit; and a same fish identification unit, wherein the fish position information acquisition unit acquires fish position information in the n measurement images, the predicted fish position information acquisition unit selects at least one selected image from the measurement images acquired prior to the (m−1)th measurement image among the n measurement images and acquires predicted fish position information (PIₘ) in the m-th measurement image on the basis of the fish position information in the at least one selected image, and on the basis of the fish position information (Iₘ) in the m-th measurement image and the corresponding predicted fish position information (PIₘ), the same fish identification unit identifies the at least one fish in the m-th measurement image as the same fish as in the at least one selected image when the fish position information (Iₘ) matches with the predicted fish position information (PIₘ) and identifies the at least one fish in the m-th measurement image as not being the same fish as in the at least one selected image when the fish position information (Iₘ) does not match with the predicted fish position information (PIₘ).

The present invention provides a fish counting system including: a terminal; and a server, wherein the terminal and the server are connectable to each other via a communication network outside the fish counting system, the terminal includes: a measurement image acquisition unit; and an output unit, wherein the measurement image acquisition unit acquires, over time, n measurement images of a region to be measured in a passage region where a fluid containing at least one fish passes through, and the output unit output an obtained fish count, the server includes: a fish position information acquisition unit; a predicted fish position information acquisition unit; a same fish identification unit; and a fish counting unit, wherein the fish position information acquisition unit acquires fish position information in the n measurement images, the predicted fish position information acquisition unit selects at least one selected image from the measurement images acquired prior to the (m−1)th measurement image among the n measurement images and acquires predicted fish position information (PIₘ) in the m-th measurement image on the basis of the fish position information in the selected image, on the basis of the fish position information (Iₘ) in the m-th measurement image and the corresponding predicted fish position information (PIₘ), the same fish identification unit identifies the at least one fish in the m-th measurement image as the same fish as in the selected image when the fish position information (Iₘ) matches with the predicted fish position information (PIₘ) and identifies the at least one fish in the m-th measurement image as not being the same fish as in the selected image when the fish position information (Iₘ) does not match with the predicted fish position information (PIₘ), and the fish counting unit counts the at least one fish on the basis of the same fish position information on the fish identified as the same fish by the same fish identification device, to obtain a fish count.

The present invention provides a fish count prediction system including: a terminal; and a server, wherein the terminal and the server are connectable to each other via a communication network outside the fish count prediction system, the terminal includes: a measurement image acquisition unit; and an output unit, wherein the measurement image acquisition unit acquires, over time, k measurement images of a region to be measured in a passage region where a fluid containing at least one fish passes through, and the output unit output a predicted fish count, the server includes: a fish position information acquisition unit; a predicted fish position information acquisition unit; a same fish identification unit; a fish counting unit; and a fish count prediction unit, wherein the fish position information acquisition unit acquires fish position information in the k measurement images, the predicted fish position information acquisition unit selects at least one selected image from the measurement images acquired prior to the (m−1)th measurement image among the k measurement images and acquires predicted fish position information (PIₘ) in the m-th measurement image on the basis of the fish position information in the selected image, on the basis of the fish position information (Iₘ) in the m-th measurement image and the corresponding predicted fish position information (PIₘ), the same fish identification unit identifies the at least one fish in the m-th measurement image as the same fish as in the selected image when the fish position information (Iₘ) matches with the predicted fish position information (PIₘ) and identifies the at least one fish in the m-th measurement image as not being the same fish as in the selected image when the fish position information (Iₘ) does not match with the predicted fish position information (PIₘ), the fish counting unit counts the at least one fish on the basis of the same fish position information on the fish identified as the same fish by the same fish identification unit, to obtain a fish count, and the fish count prediction unit predicts a fish count of the at least one fish passed through the passage region on the basis of the fish count obtained from k measurement images within time set in advance by the fish counting unit, the time set in advance, and total time required for the fluid containing the at least one fish to pass through the passage region.

### Effects of the Invention

The present invention can easily identify the same fish. The present invention thus can identify, for example, the same fish in the presence of a plurality of fish in each of the measurement images and therefore can prevent overlapping counting and can efficiently count fish.

### BRIEF DESCRIPTION OF DRAWINGS

FIG. 1 is a block diagram showing a same fish identification device according to an embodiment (first embodiment) of the present invention.

FIG. 2 is a flowchart showing a same fish identification method and a program according to an embodiment (first embodiment) of the present invention.

FIG. 3 is another flowchart showing the same fish identification method and the program according to the embodiment (first embodiment) of the present invention.

FIG. 4 is a block diagram showing a fish counting device according to an embodiment (second embodiment) of the present invention.

FIG. 5 is a flowchart showing a fish counting method and a program according to the embodiment (second embodiment) of the present invention.

FIG. 6A is a flowchart showing the fish counting method and the program according to the embodiment (second embodiment) of the present invention.

FIG. 6B is another flowchart showing the fish counting method and the program according to the embodiment (second embodiment) of the present invention.

FIG. 7 is a flowchart showing a fish counting method and a program according to an embodiment (third embodiment) of the present invention.

FIG. 8A is another flowchart showing the fish counting method and the program according to the embodiment (third embodiment) of the present invention.

FIG. 8B is yet another flowchart showing the fish counting method and the program according to the embodiment (third embodiment) of the present invention.

FIG. 8C is yet another flowchart showing the fish counting method and the program according to the embodiment (third embodiment) of the present invention.

FIG. 8D is yet another flowchart showing the fish counting method and the program according to the embodiment (third embodiment) of the present invention.

FIG. 8E is yet another flowchart showing the fish counting method and the program according to the embodiment (third embodiment) of the present invention.

FIG. 8F is yet another flowchart showing the fish counting method and the program according to the embodiment (third embodiment) of the present invention.

FIG. 9 is a block diagram showing a fish count prediction device according to an embodiment (fifth embodiment) of the present invention.

FIG. 10 is a flowchart showing a fish count prediction method and a program according to the embodiment (fifth embodiment) of the present invention.

FIG. 11 is a schematic view of an operation screen of a fish counting device according to an embodiment (sixth embodiment) of the present invention.

FIG. 12 is a flowchart showing an operation of the fish counting device according to the embodiment (sixth embodiment) of the present invention.

FIG. 13 is a block diagram showing a same fish identification system according to an embodiment (eighth embodiment) of the present invention.

### DESCRIPTION OF EMBODIMENTS

In the present invention, the “fish” mean fish and shellfish. Examples of the fish and shellfish include fish and crustacea. The fish are not limited to particular fish, and examples thereof include flathead gray mullet, a sardine, an eel, a tuna, an eastern little tuna, an amberjack, a globefish, a flounder, a sea-bream, a greater amberjack, a horse-mackerel, and chub mackerel. Examples of the crustacea include shrimps. In the present invention, one or more kinds of fish may be used.

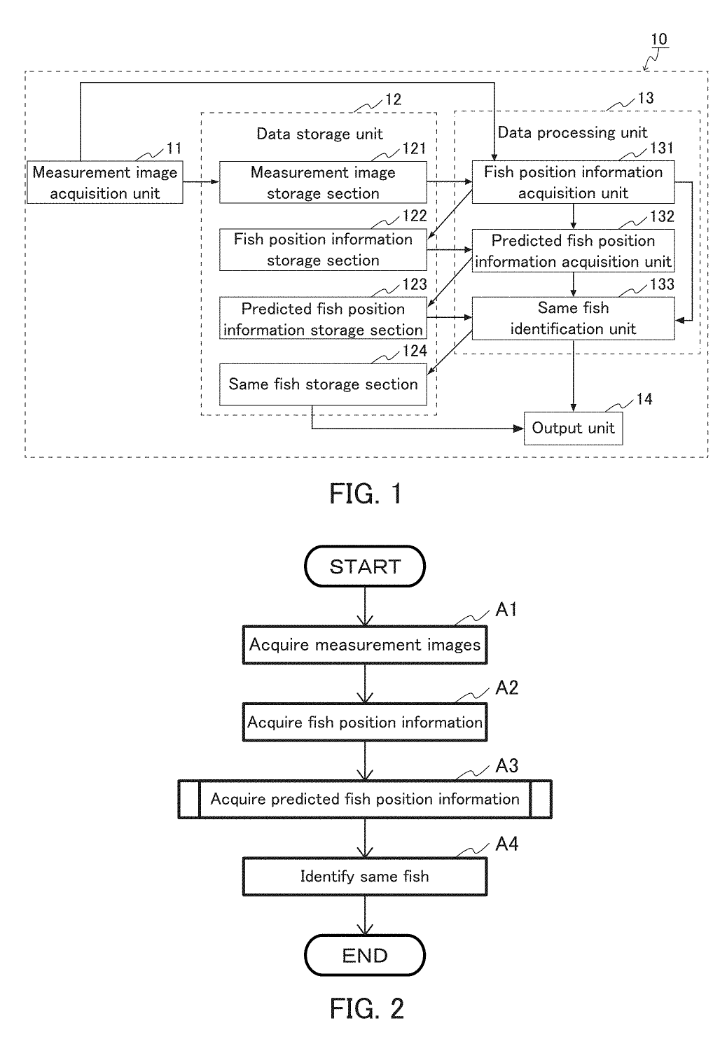

The following describes embodiments of the present invention. The present invention, however, is by no means limited thereto. In FIGS. 1 to 13, the identical parts are denoted by identical reference numerals. Each of the embodiments can be described with reference to the descriptions of the other embodiments, unless otherwise mentioned. The configurations of the embodiments can be combined, unless otherwise mentioned.

### First Embodiment

The first embodiment relates to the same fish identification device and the same fish identification method of the present invention.

The same fish identification device and the same fish identification method according to the present embodiment can easily identify the same fish, for example.

FIG. 1 is a block diagram of the same fish identification device according to the present embodiment. As shown in FIG. 1, the same fish identification device 10 according to the present embodiment includes a measurement image acquisition unit 11, a measurement image storage section 121, a fish position information storage section 122, a predicted fish position information storage section 123, a same fish storage section 124, a fish position information acquisition unit 131, a predicted fish position information acquisition unit 132, a same fish identification unit 133, and an output unit 14. As shown in FIG. 1, the measurement image storage section 121, the fish position information storage section 122, the predicted fish position information storage section 123, and the same fish storage section 124 may be incorporated in a data storage unit 12 that is hardware, for example. As shown in FIG. 1, the fish position information acquisition unit 131, the predicted fish position information acquisition unit 132, and the same fish identification unit 133 may be incorporated in a data processing unit (data processing device) 20 or may be software or hardware incorporating the software, for example. The data processing unit 13 may include, for example, CPU. The measurement image storage section 121, the fish position information storage section 122, the predicted fish position information storage section 123, the same fish storage section 124, and the output unit 14 are optional components, and the same fish identification device 10 may or may not include the optional components or may include some of the optional components.

The measurement image storage section 121 may be electrically connected to the measurement image acquisition unit 11 and the fish position information acquisition unit 131;

the fish position information storage section 122 to the fish position information acquisition unit 131, the predicted fish position information acquisition unit 132, and the same fish identification unit 133; the predicted fish position information storage section 123 to the predicted fish position information acquisition unit 132 and the same fish identification unit 133; and the same fish storage section 124 to the same fish identification unit 133 and the output unit 14. In the same fish identification device 10, the measurement images may be stored in the data storage unit 12, and the stored measurement images are output to the data processing unit 13 to perform data processing. Alternatively, in the same fish identification device 10, the measurement images are input to the data processing unit 13 to perform data processing.

The measurement image acquisition unit 11 acquires, over time, n measurement images of a region to be measured in a passage region where a fluid containing fish passes through. The measurement image acquisition unit 11 is not limited to particular units, and examples thereof include an imaging unit configured to take the measurement images and a data storage unit configured to store the taken measurement images. Examples of the imaging unit include: a still camera; a video camera; and camera-equipped mobile terminals such as a camera-equipped mobile phone, a camera-equipped smartphone, and a camera-equipped tablet terminal; a web camera-equipped computer; and a camera-equipped head-mounted display. Examples of the data storage unit include a random access memory (RAM), a read-only memory (ROM), a flash memory, a hard disc (HD), an optical disc, and a floppy (registered trademark) disc (FD). The data storage unit may be an internal data storage memory or an external data storage memory such as an external storage.

The region to be measured may be, for example, a part or the whole of the passage region where a fluid containing fish passes through. The n measurement images of the region to be measured acquired over time may be images of the same region (i.e., images of one place) or images of a plurality of parts in the region to be measured (images of a plurality of places). In the latter case, in a specific example, the measurement images can be images of a plurality of parts overlapping with one another in the region to be measured.

The measurement images may be images of only the region to be measured or images of an area including the region to be measured. In the latter case, the measurement images may be, for example, images of an area including the region to be measured and another region(s). Another region(s) can be, for example, a region other than the passage region where a fluid containing fish passes through. The measurement images can be acquired by taking images with the imaging unit at the time when a fluid containing fish passes through the passage region. The measurement images thus may include one or both of an image including the fish and an image including no fish. The fluid is not limited to particular fluids and can be determined, as appropriate, according to the kinds of the fish. Examples of the fluid include water, fresh water, seawater, and artificial seawater. The measurement images are preferably obtained by taking images of a region to be measured in a passage region where a fluid containing fish passes through on a monochrome background for improving the accuracy of detecting the fish in the measurement images. The monochrome background can be, for example, a white background.

The frequency of acquiring the measurement images at the time when the fish pass through the region to be measured is not limited to particular frequencies. The lower limit is, for example, 3 FPS (Flames Per Second), preferably 12 FPS, more preferably 20 FPS, and the upper limit is not limited to particular values.

The “n” is only required to be a positive integer of two or more, and the upper limit is not limited to particular values. The “n” measurement images are, for example, two or more measurement images, preferably three or more measurement images, more preferably five or more measurement images.

The fish position information acquisition unit 131 acquires fish position information on position of each fish in each of the n measurement images. In the case of setting a coordinate plane on the measurement images, the fish position information can be, for example, coordinates or an area on the coordinate plane. Either of the coordinates or the area or both of them may be acquired as the fish position information. For the coordinates as the fish position information, examples of the fish position information include a position of one body part of each fish, an average of positions of two or more body parts of each fish, a position of the center of gravity of each fish, and the position (of the pixel) at the maximum of the feature quantity such as the brightness. The body part of each fish is not limited to particular parts, and examples thereof include an eye, a jaw, a back fin, a caudal fin, a breast fin, and an anal fin. For the area as the fish position information, examples of the fish position information include an outline of each fish and an area enclosed in the outline.

The predicted fish position information acquisition unit 132 selects a selected image(s) from measurement images acquired prior to the (m−1)th measurement image among the n measurement images. The predicted fish position information acquisition unit 132 then acquires, on the basis of the fish position information in the selected image, information (PIₘ) on a predicted position of each fish in the m-th measurement image (hereinafter also merely referred to as the predicted fish position information (PIₘ)) as a position of each fish in the m-th measurement image. The range of the “m” is, for example, a range of 1 to n that is any positive integer. The number of the selected images may be, for example, 1 or more and is preferably all (n) to increase prediction accuracy. For example, the predicted fish position information acquisition unit 132 may acquire the predicted fish position information (PIₘ) by reading it out on the basis of a table (prediction table) obtained by associating the fish position information in the selected image and the predicted fish position information (PIₘ) or may acquire it by calculating the predicted fish position information (PIₘ) on the basis of the fish position information in the selected image. The predicted fish position information (PIₘ) may be, for example, coordinates or an area on the coordinate plane or both of them. For the coordinates as the predicted fish position information (PIₘ), the predicted fish position information (PIₘ) may be the coordinates and an area within a predetermined distance from the coordinates. The predetermined distance can be set, as appropriate, according to the kinds of the fish, for example.

The same fish identification unit 133 identifies whether or not each fish in the m-th measurement image is the same fish as in the selected image on the basis of information (Iₘ) on a position of each fish in the m-th measurement image (hereinafter also merely referred to as the fish position information (Iₘ)) and the corresponding predicted fish position information (PIₘ). When the fish position information (Iₘ) matches with the predicted fish position information (PIₘ), the same fish identification unit 133 identifies the fish in the m-th measurement image as the same fish as in the selected image. When the fish position information (Iₘ) does not match with the predicted fish position information (PIₘ), the same fish identification unit 133 identifies the fish in the m-th measurement image as not being the same fish as in the selected image.

The output unit 14 output, for example, the identification of the fish in the m-th measurement image being the same fish as in the selected image or not. Examples of the output unit 14 include: a monitor (e.g., various image displays such as a liquid crystal display (LCD), a cathode-ray tube (CRT) display; a printer of print output; and a speaker of audio output.

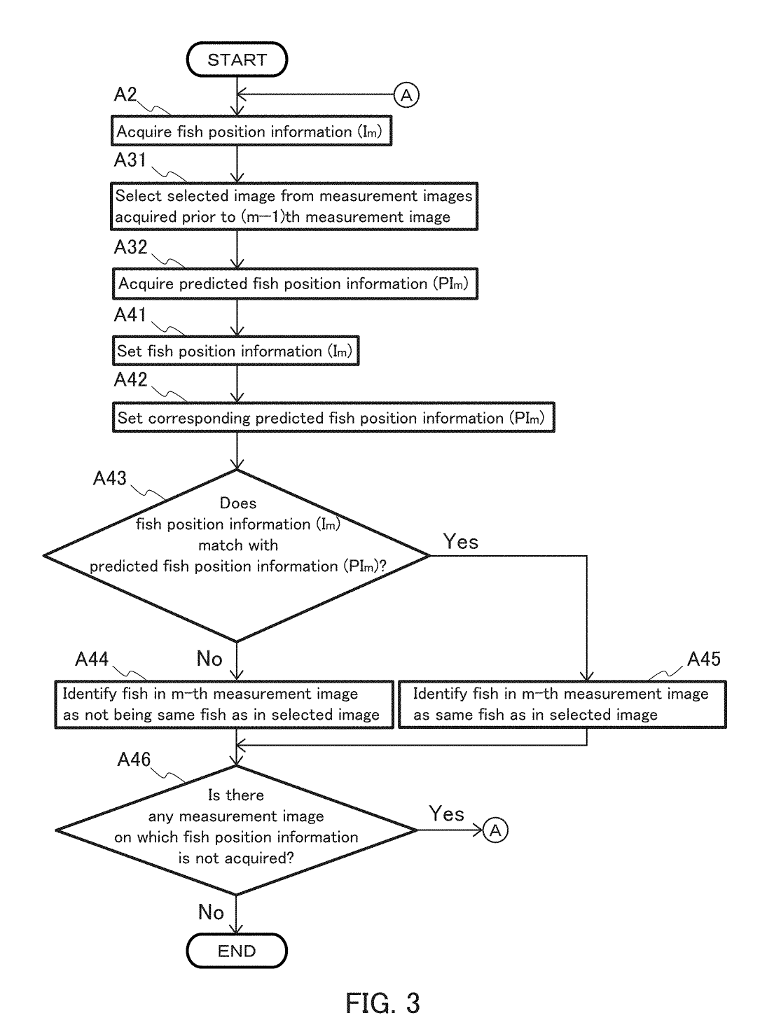

FIGS. 2 and 3 are flowcharts of the same fish identification method according to the present embodiment. The same fish identification method according to the present embodiment is performed as follows using the same fish identification device of FIG. 1, for example. As shown in FIG. 2, the same fish identification method according to the present embodiment includes a step A1 (measurement image acquisition), a step A2 (fish position information acquisition), a step A3 (predicted fish position information acquisition), and a step A4 (same fish identification).

(A1) Measurement Image Acquisition

In the step A1, n measurement images of a region to be measured in a passage region where a fluid containing fish passes through are acquired over time. For acquisition of the measurement images using the imaging unit, images of the passage region where a fluid containing fish passes through are taken and acquired as the measurement images. For acquisition of the measurement images using the data storage unit, measurement images stored in the data storage unit (not shown) are read out and acquired. The acquired measurement images are then stored in the measurement image storage section 121.

(A2) Fish Position Information Acquisition

In the step A2, the fish position information in the n measurement images is acquired. The order of acquiring the fish position information is not limited to particular orders, and the fish position information may be acquired in accordance with the order of acquiring the measurement images. Alternatively, the measurement images may be acquired randomly. In the measurement images, the fish can be detected by, for example, an identification based on color, an extraction of outlines, and template matching of comparing previously stored images of the fish and the measurement images and searching for similar areas. For example, a coordinate plane is set on the measurement images, and the fish position information is acquired as coordinates or an area on the coordinate plane. When a plurality of fish is present in the measurement images, the positions of the respective fish are acquired. The acquired fish position information is then stored in the fish position information storage section 122.

(A3) Predicted Fish Position Information Acquisition

At least one image is then selected from the measurement images acquired prior to the (m−1)th measurement image among the n measurement images (A31). The predicted fish position information (PIₘ) in the m-th measurement image is thereafter acquired on the basis of the fish position information in the selected image (A32). The predicted fish position information (PIₘ) may be, for example, acquired in accordance with the order of acquiring the n measurement images. Alternatively, the m-th measurement image may be selected randomly, and the predicted fish position information (PIₘ) then may be acquired. For acquisition of the predicted fish position information (PIₘ) using the prediction table, the predicted fish position information (PIₘ) is read out and acquired in the step A32. For calculation of the predicted fish position information (PIₘ), the predicted fish position information (PIₘ) is calculated and acquired by, for example, known prediction algorithms such as a Kalman filter, a particle filter, and KLT (Kanade Lucas Tomasi) tracker on the basis of the coordinates of the fish in the selected image on the coordinate plane set on the measurement images in the step A32. The predicted fish position information (PIₘ) may be calculated as coordinates or an area a certain distance away from the coordinates of each fish in the selected image in the direction in which the fluid flows on a coordinate plane set in the measurement images, on the basis of the fish position information in the selected image and the direction in which the fluid flows, for example.

When the steps A2 to A4 are performed in order of acquiring the measurement images, a step A31′ of acquiring the predicted fish position information (PIₘ) in the m-th measurement image on the basis of the first to (m−1)th measurement images and storing the information in a predicted fish position information storage section 123 may be performed as a substitute for the step A31 after the step A4. In this case, in the step A32, the predicted fish position information (PIₘ) stored in the predicted fish position information storage section 123 may be acquired. The acquired predicted fish position information (PIₘ) is then stored in the predicted fish position information storage section 123. When a plurality of fish is present in the selected image, the predicted fish position information (PIₘ) is acquired in the step A3.

(A4) Same Fish Identification

The fish position information (Iₘ) in the m-th measurement image is set (A41), and the corresponding predicted fish position information (PIₘ) is set (A42), and whether the fish in the m-th measurement image are the same fish as in the selected image is identified (A43) on the basis of the fish position information (Iₘ) and the predicted fish position information (PIₘ). The identification can be made by, for example, whether the fish position information (Iₘ) on the coordinate plane set on the measurement images satisfies the corresponding predicted fish position information (PIₘ). For coordinates as the fish position information (Iₘ) and the predicted fish position information (PIₘ), the identification can be made by whether the coordinates as the fish position information (Iₘ) match with those as the predicted fish position information (PIₘ). For areas as the fish position information (Iₘ) and the predicted fish position information (PIₘ), the identification can be made by whether the areas overlap with each other. For coordinates as one of the fish position information (Iₘ) or the predicted fish position information (PIₘ) and an area as the other information, the identification can be made by whether the coordinates overlap with the area. If No, i.e., if the fish position information (Iₘ) does not match with the predicted fish position information (PIₘ), the fish in the m-th measurement image are identified as not being the same fish as in the selected image (A44). If Yes, i.e., if the fish position information (Iₘ) matches with the predicted fish position information (PIₘ), the fish in the m-th measurement image are identified as the same fish as in the selected image (A45). When a plurality of fish is present in each of the measurement images, whether each fish in the m-th measurement image is the same as each fish in the selected image is identified with respect to all combinations on the basis of each piece of information on the position of each fish in the fish position information (Iₘ) and each piece of information of the predicted position of each fish in the predicted fish position information (PIₘ). The fish position information (Iₙ) matching with the predicted fish position information (PIₘ) is associated with the predicted fish position information (PIₘ) and is stored in the same fish storage section 124.

The presence or absence of a measurement image on which fish position information has not been acquired is checked (A46). If Yes, i.e., if there is a measurement image on which fish position information is not acquired, the same steps are performed from the step A2. In this case, in the steps A31 and A32, predicted fish position information (e.g., predicted fish position information (PIₘ₊₁)) that has not be acquired is acquired, and in the steps A41 to A45, whether the acquired predicted fish position information matches with the corresponding fish position information (e.g., fish position information (Iₘ₊₁) is identified. If No, i.e., if there is no measurement image on which fish position information is not acquired, the process is finished.

In the same fish identification device 10 according to the present embodiment, the measurement image acquisition unit 11 may be electrically connected to the fish position information acquisition unit 131; the fish position information acquisition unit 131 to the predicted fish position information acquisition unit 132 and the same fish identification unit 133; the predicted fish position information acquisition unit 132 to the same fish identification unit 133; and the same fish identification unit 133 to the output unit 14. In this case, for example, the fish position information acquisition unit 131 acquires fish position information in the measurement images acquired by the measurement image acquisition unit 11, the predicted fish position information acquisition unit 132 acquires predicted fish position information (Iₘ) on the basis of the acquired fish position information, and the same fish identification unit 133 performs the identification on the basis of the acquired fish position information (Iₙ) and the corresponding predicted fish position information (PIₘ). For an output of the measurement images, the fish position information (Iₘ), and the predicted fish position information (PIₘ) to the output unit 14, the measurement image storage section 121, the fish position information storage section 122, and the predicted fish position information storage section 123 may be electrically connected to the output unit 14, or alternatively, the measurement image acquisition unit 11, the fish position information acquisition unit 131, and the predicted fish position information acquisition unit 132 may be electrically connected to the output unit 14.

The same fish identification device 10 may further include an input unit. In the same fish identification device 10 according to the present embodiment including an input unit, the input unit may be connected to, for example, the measurement image acquisition unit 11 or the same fish identification unit 133. With the input unit connected to the measurement image acquisition unit 11, information on start and stop of acquisition of the measurement images is input, for example. With the input unit connected to the same fish identification unit 133, information on start and stop of identification of the same fish or not is input.

### First Modification

The modification 1 relates to the same fish identification device and the same fish identification method of the present invention. The same fish identification device and the same fish identification method according to the first modification can be described with reference to the descriptions of the same fish identification device and the same fish identification method according to the first embodiment, for example.

The same fish identification device and the same fish identification method according to the first modification can detect the position of fish more rapidly based on the structure of the fish and thus can acquire the position of the fish more rapidly. The same fish identification device and the same fish identification method according to the first modification thus can identify the same fish more rapidly.

In the same fish identification device according to the first modification, the fish position information acquisition unit preferably acquires an area(s) satisfying a color condition as the fish position information. Other than this, the same fish identification device according to the first modification has the same configuration as the same fish identification device according to the first embodiment.

The color condition is a condition of color to be determined as fish and can be set, as appropriate, according to the color of fish to be determined. The color condition may be set in advance, set in use, or set during use. For measurement images shown using a RGB color system, the color condition can be set as reference values of color differences among an R-value, G-value, and B-value, for example. Specifically, the fish position information acquisition unit acquires, for example, an area(s) having color differences lower than predetermined values as the fish position information. For measurement images shown using L*a*b color system, the color condition can be set as an L-value, for example. Specifically, when the L-value of fish is lower than the L-value of a measurement image including no fish, the fish position information acquisition unit acquires, for example, as the fish position information, an area(s) having an L-value lower than the predetermined value in the measurement images, or an area(s) at a predetermined ratio of an L-value to the maximum L-value in the measurement images or less. The predetermined ratio of the L-value to the maximum L-value is, for example, 1 or less. When the L-value of fish is higher than the L-value of a measurement image including no fish, the fish position information acquisition unit acquires, for example, as the fish position information, an area(s) having an L-value higher than the predetermined value in the measurement images, or an area(s) at a predetermined ratio of an L-value to the minimum L-value in the measurement images or more. The predetermined ratio of the L-value to the minimum L-value is, for example, higher than 1. By the fish position information acquisition unit, the color system by which the measurement images are shown, which is different from the color system of the color condition, may be converted to the color system used in the color condition, and an area(s) satisfying the color condition may be acquired as the fish position information, for example. The conversion can be performed using a method for converting a known color system such as an RGB color system, an HSV color system, a YCrCb color system, or a L*a*b color system to another color system, for example.

In the fish position information acquisition step of the same fish identification method according to the first modification, an area(s) satisfying the color condition in the n measurement images is preferably acquired as the fish position information. Other than this, the same fish identification method according to the first modification is the same as that according to the first embodiment.

For example, in the fish position information acquisition step, an area(s) satisfying the color condition is searched for in color of the measurement images. When there is an area satisfying the color condition in the measurement images, coordinates of the area on the coordinate plane or the area is acquired as the fish position information. When there is no area satisfying the color condition in the measurement images, the fish position information is not acquired. In the fish position information acquisition step, the color system by which the measurement images are shown may be converted into a color system used in the color condition, and an area(s) satisfying the color condition is acquired as the fish position information, for example.

### Second Modification

The second modification relates to the same fish identification device and the same fish identification method of the present invention. The same fish identification device and the same fish identification method according to the second modification can be described with reference to the descriptions of the same fish identification device and the same fish identification method according to the first embodiment, for example.

The same fish identification device and the same fish identification method according to the second modification can detect the position of fish more rapidly based on the structure of the fish and thus can acquire the position of the fish more rapidly. The same fish identification device and the same fish identification method according to the second modification thus can identify the same fish more rapidly.

It is preferred that the same fish identification device according to the second modification further includes a subtracted image production unit, and the subtracted image production unit produces subtracted images which are differences between the respective n measurement images and a reference image, and the fish position information acquisition unit acquires an area(s) satisfying a color change condition in the subtracted images as the fish position information. Other than this, the same fish identification device according to the second modification has the same configuration as the same fish identification device according to the first embodiment.

The reference image can be, for example, a background image or a previous measurement image of a target measurement image. In the former case, the background image can be, for example, a measurement image containing no fish. In the latter case, the reference image is the (m−1)th measurement image, and in this case, a subtracted m-th image is a subtracted image between the m-th measurement image and the (m−1)th measurement image, and the 0-th measurement image is, for example, a measurement image containing no fish, for example. The color change condition is, for example, a condition of color change to be determined as fish between each of the measurement images and the reference image and can be set, as appropriate, according to the color of the fish to be determined. The color change condition may be set in advance, set in use, or set during use, for example. The color change condition can be set in the same manner as for the color condition, for example.

It is preferred that the same fish identification method according to the second modification further includes a subtracted image production step, in the subtracted image production step, subtracted images that are differences between the respective measurement images and the reference image are produced, and in the fish position information acquisition step, at least one area satisfying the color change condition in the subtracted images is acquired as the fish position information. Other than this, the same fish identification method according to the second modification is the same as that according to the first embodiment.

In the subtracted image production step, each subtracted image that is a difference between each of the measurement images and the reference image is produced, for example. The subtracted image can be produced using a known algorithm such as a background subtraction algorithm or an inter-frame subtraction algorithm. Specifically, for the measurement images and the reference image shown using an RGB color system, each subtracted image can be calculated by subtracting, from an R-value, G-value, and B-value of each of the measurement images, an R-value, G-value, and a B-value at corresponding coordinates in the reference image, for example. Moreover, for the measurement images and the reference image shown using an L*a*b color system, each subtracted image can be calculated by subtracting, from an L-value, an a-value, and a b-value of each of the measurement images, an L-value, an a-value, and a b-value at the corresponding coordinates in the reference image for example.

In the fish position information acquisition step, an area(s) in a color of the subtracted images, i.e., a color change between each of the measurement images and the reference image, satisfying the color change condition is searched for, for example. In the fish position information acquisition step, when there is an area satisfying the color change condition in the subtracted images, coordinates of the area or the area on the coordinate plane is obtained as the fish position information, for example. When there is no area satisfying the color change condition in the subtracted images, a fish position is not acquired.

### Third Modification

The third modification relates to the same fish identification device and the same fish identification method of the present invention. The same fish identification device and the same fish identification method according to the third modification can be described with reference to the descriptions of the same fish identification device and the same fish identification method according to the first embodiment, for example.

The same fish identification device and the same fish identification method according to the third modification can detect the position of fish more rapidly based on the structure of the fish and thus can acquire the position of the fish more rapidly. The same fish identification device and the same fish identification method according to the third modification thus can identify the same fish more rapidly.

It is preferred that the same fish identification device according to the third modification further includes an outline extraction unit, and the outline extraction unit extracts an outline(s) from the n measurement images, and the fish position information acquisition unit acquires an area(s) enclosed in the outline as the fish position information. The fish position information acquisition unit may acquire the outline as the fish position information as substitute for the area enclosed in the outline. Other than this, the same fish identification device according to the third modification has the same configuration as the same fish identification device according to the first embodiment.

The outline can be, for example, an outline of fish.

It is preferred that the same fish identification method according to the third modification further includes an outline extraction step, an outline(s) is extracted from the n measurement images in the outline extraction step, and an area(s) enclosed in the outline is acquired as the fish position information in the fish position information acquisition step. Other than this, the same fish identification method according to the third modification is the same as that according to the first embodiment.

In the outline extraction step, an outline(s) is extracted from the measurement images. The extraction can be performed by, for example, known edge detection method using a Canny filter, a Sobel filter, or a Laplacian filter.

In the fish position information acquisition step, when there is an area enclosed in the outline, coordinates of the area or the area on the coordinate plane is acquired as the fish position. When there is no area enclosed in the outline, a fish position is not acquired. In the fish position information acquisition step, the outline may be acquired as the fish position information as substitute for the area enclosed in the outline.

### Fourth Modification

The fourth modification relates to the same fish identification device and the same fish identification method of the present invention. The same fish identification device and the same fish identification method according to the fourth modification can be described with reference to the descriptions of the same fish identification device and the same fish identification method according to the first embodiment, for example.

The same fish identification device and the same fish identification method according to the fourth modification can detect the passage region through which fish passed and can remove noises in the measurement images including areas other than the passage region and thus can acquire the fish position information more accurately, for example. The same fish identification device and the same fish identification method according to the fourth modification thus can identify the same fish more accurately.

It is preferred that the same fish identification device according to the fourth modification further includes a passage region detection unit, and the passage region detection unit detects a passage region in the n measurement images. Other than this, the same fish identification device according to the fourth modification has the same configuration as the same fish identification device according to the first embodiment.

It is preferred that the same fish identification method according to the fourth modification further includes a passage region detection step, and in the passage region detection step, a passage region in the n measurement images is detected. Other than this, the same fish identification method according to the fourth modification is the same as that according to the first embodiment.

In the passage region detection step, a passage region is detected from the measurement images. The detection can be made by, for example, detecting the shape of the passage region. For a rectangle passage region, the detection is, for example, a detection of a straight line. For the detection of a straight line, a combination of hough transformation and a Sobel filter can be used, for example. The detection can be made, for example, with respect to the entire measurement images or partial regions of the measurement images.

### Fifth Modification

The fifth modification relates to the same fish identification device and the same fish identification method of the present invention. The same fish identification device and the same fish identification method according to the fifth modification can be described with reference to the descriptions of the same fish identification device and the same fish identification method according to the first embodiment, for example.

The same fish identification device and the same fish identification method according to the fifth modification can reduce an erroneous detection by reducing noises in images, thus can improve accuracy of detecting fish, and therefore can acquire the fish position information more accurately, for example. The same fish identification device and the same fish identification method according to the fifth modification thus can accurately identify the same fish.

It is preferred that the same fish identification device according to the fifth modification further includes an image smoothing unit, and the image smoothing unit produces smoothed images by smoothing images. Other than this, the same fish identification device according to the fifth modification has the same configuration as the same fish identification device according to the first embodiment.

Examples of the images include the measurement images, the reference image, the background image, and the subtracted images. Examples of the smoothed images of the measurement images, the reference image, the background image, and the subtracted image as the smoothed images include smoothed measurement images, a smoothed reference image, a smoothed background image, and smoothed subtracted images. The image smoothing unit may smooth one or two kinds of the images, for example.

It is preferred that the same fish identification method according to the fifth modification further includes an image smoothing step, and in the image smoothing step, smoothed images are produced by smoothing images. Other than this, the same fish identification method according to the fifth modification is the same as that according to the first embodiment.

In the image smoothing step, the images are smoothed. The smoothing can be performed by, for example, a known smoothing method using a box filter, Gaussian filter, or a medium filter. One or more or all of the colors in each of the color systems may be subjected to the smoothing, for example.

Each of the same fish identification device and the same fish identification method according to the fifth modification may be combined with, for example, each of the same fish identification device and the same fish identification method according to any of the first embodiment and the first modification to the fourth modification or a combination thereof. In this case, at least one unit in any of the first embodiment and the first modification to the fourth modification or a combination thereof uses, as substitute for the images used in the unit, the corresponding smoothed image(s).

### Sixth Modification

The sixth modification relates to the same fish identification device and the same fish identification method of the present invention. The same fish identification device and the same fish identification method according to the sixth modification can be described with reference to the descriptions of the same fish identification device and the same fish identification method according to the first embodiment, for example.

The same fish identification device and the same fish identification method according to the sixth modification can remove position information that was erroneously detected as fish and thus can accurately acquire fish position information, for example. The same fish identification device and the same fish identification method according to the sixth modification thus can accurately identify the same fish.

It is preferred that in the same fish identification device according to the sixth modification, the fish position information acquisition unit further includes an erroneously detected position information removal unit, the erroneously detected position information removal unit removes position information satisfying an erroneous detection condition as erroneous information, and the fish position information acquisition unit acquires, as fish position information, information after removing the erroneous information. Other than this, the same fish identification device according to the sixth modification has the same configuration as the same fish identification device according to the first embodiment.

Examples of the erroneous detection include the case where a plurality of pieces of fish position information is acquired as one fish and the case where information on an area which does not indicate fish is acquired as the fish position information. The erroneous detection may be detected on the basis of the fish position information on one kind of fish, acquired from the measurement images or the fish position information on plural kinds of fish, acquired from the measurement images. In the latter case, the fish position information on plural kinds of fish can be acquired using a combination of the first embodiment and the first modification to the third modification, for example.

When the erroneous detection is the case where a plurality of pieces of fish position information is acquired as the fish position information on one fish, the erroneous detection condition can be, for example, an overlapping ratio of areas indicated by the plurality of pieces of fish position information. When the erroneous detection is the case where information on an area which does not indicate fish is acquired as the fish position information, the erroneous detection condition can be, for example, the size of an area indicated by the fish position information or a bias of a histogram of the distribution of gradients of an area indicated by the fish position information. The histogram of the distribution of gradients can be, for example, a histogram of distribution of 8 gradient directions.

It is preferred that in the same fish identification method according to the sixth modification, the position information acquisition step further includes an erroneously detected position information removal step, and in the erroneously detected position information removal step, fish position information satisfying an erroneous detection condition is removed as erroneous information, and in the fish position information acquisition step, information after removing the erroneous information is acquired as fish position information. Other than this, the same fish identification method according to the sixth modification is the same as that according to the first embodiment.

In the erroneously detected position information removal step, fish position information satisfying the erroneous detection condition is removed from the obtained fish position information. When the erroneous detection is the case where a plurality of pieces of fish position information is acquired as the fish position information on one fish, the erroneous detection condition is, for example, an overlapping ratio of areas indicated by the plurality of pieces of fish position information, and the pieces of fish position information, having the overlapping ratio higher than a predetermined ratio are integrated to be one fish position information, thereby the erroneous information is removed. When the erroneous detection is the case where information on an area which does not indicate fish is acquired as the fish position information, the erroneous detection condition is, for example, the size of an area indicated by the fish position information, and fish position information indicating the area having a size smaller than a predetermined size is removed to remove the erroneous information.

When the erroneous detection is the case where information on an area which does not indicate fish is acquired as the fish position information, the erroneous detection condition is, for example, a bias of a histogram of the distribution of gradients of an area indicated by the fish position information, and fish position information indicating an area having a bias of a histogram of the distribution of gradients smaller than a predetermined bias is removed to remove the erroneous information.

### Seventh Modification

The seventh modification relates to the same fish identification device and the same fish identification method of the present invention. The same fish identification device and the same fish identification method according to the seventh modification can be described with reference to the descriptions of the same fish identification device and the same fish identification method according to the first embodiment, for example.

The same fish identification device and the same fish identification method according to the seventh modification can detect an erroneous identification of identifying a fish in the selected image as the same fish as a plurality of fish in the measurement images, for example.

The same fish identification device and the same fish identification method according to the seventh modification thus can identify the same fish more accurately.

It is preferred that the same fish identification device according to the seventh modification further includes an erroneous identification detection unit, and the erroneous identification detection unit detects an identification satisfying an erroneous identification condition as an erroneous identification.

The erroneous identification can be, for example, an identification of fish in measurement images as the same fish as different fish in the selected image. The erroneous identification condition can be, for example, an identification of one fish in the selected image as the same fish as a plurality of fish in the measurement images or an identification of a plurality of fish in the selected image as the same fish as one fish in a measurement image. When an erroneous identification is detected, the erroneous identification detection unit further includes a re-identification unit that identifies whether the fish which have been erroneously identified in the measurement images are the same fish as in the selected image other than the fish that has been erroneously identified on the basis of the fish position information (Iₘ) and the predicted fish position information (PIₘ). In this case, the identification can be made in the same manner as in the same fish identification unit, for example.

It is preferred that the same fish identification method according to the seventh modification further includes an erroneous identification detection step, and in the erroneous identification detection step, an identification satisfying an erroneous identification condition is identified as an erroneous identification. Other than this, the same fish identification method according to the seventh modification is the same as that according to the first embodiment.

In the erroneous identification detection step, when an identification obtained in the same fish identification step satisfies the erroneous identification condition, the identification is detected as an erroneous identification, for example. In the case where the erroneous identification condition is an identification of one fish in the selected image as the same fish as a plurality of fish in the measurement images, whether each fish in the selected image is identified as the same fish as a plurality of fish in the measurement images is considered in the erroneous identification detection step. When a fish in the selected image is identified as the same fish as the plurality of fish in the measurement images, this identification is detected as an erroneous identification. When the erroneous identification is detected, the erroneous identification detection step may further include a re-identification step of identifying whether the fish which have been erroneously identified in the measurement images are the same fish as in the selected image other than the fish that has been erroneously identified on the basis of the fish position information (Iₘ) and the predicted fish position information (PIₘ). In this case, the identification can be made in the same manner as in the same fish identification step, for example.

The first modification to the seventh modification may be used alone, preferably used in combination of two or more of them because the same fish can be identified more rapidly and more accurately, and more preferably used in combination of all because the same fish can be identified further more rapidly and further more accurately. The combination of two or more of them is not limited to particular combinations and may be any combination. When the respective pieces of the fish position information acquired in the modifications are combined, all pieces of the fish position information may be acquired as the fish position information;

overlapping pieces of the fish position information among the respective pieces of the fish position information acquired in the modifications may be integrated and acquired as the fish position information; or the overlapping pieces of the fish position information among the respective pieces of the fish position information acquired in the modifications may be acquired as the fish position information.

### Second Embodiment

The second embodiment relates to the fish counting device and the fish counting method of the present invention.

The fish counting device and the fish counting method according to the present embodiment can accurately detect the same fish, for example. The fish counting device and the fish counting method according to the present embodiment thus can accurately count fish, for example. The fish counting device and the fish counting method according to the present embodiment can be described with reference to the descriptions of the same fish identification device and the same fish identification method according to the first embodiment, for example.

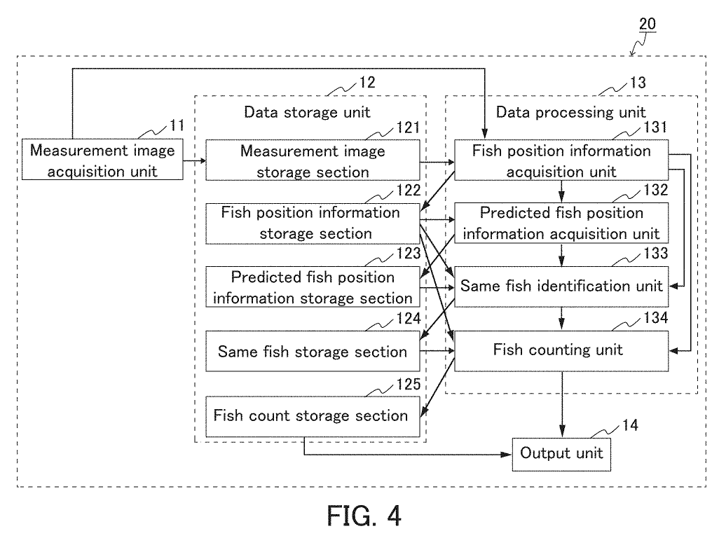

FIG. 4 is a block diagram showing a fish counting device according to the present embodiment. As shown in FIG. 4, the fish counting device 20 according to the present embodiment includes: a measurement image acquisition unit 11, a measurement image storage section 121, a fish position information storage section 122, a predicted fish position information storage section 123, a same fish storage section 124, a fish count storage section 125, a fish position information acquisition unit 131, a predicted fish position information acquisition unit 132, a same fish identification unit 133, a fish counting unit 134, and an output unit 14. For example, as shown in FIG. 4, the measurement image storage section 121, the fish position information storage section 122, the predicted fish position information storage section 123, the same fish storage section 124, and the fish count storage section 125 may be incorporated in a data storage unit 12 that is hardware. The fish position information acquisition unit 131, the predicted fish position information acquisition unit 132, the same fish identification unit 133, and the fish counting unit 134 may be incorporated in a data processing unit (data processing device) 13 that is hardware as shown in FIG. 4 or may be software or hardware incorporating the software, for example. The data processing unit 13 may include, for example, CPU. The measurement image storage section 121, the fish position information storage section 122, the predicted fish position information storage section 123, the same fish storage section 124, the fish count storage section 125, and the output unit 14 are optional components, and the fish counting device 20 may or may not include the optional components or may include some of the optional component.

The fish position information storage section 122 is further electrically connected to the fish counting unit 134, and the fish count storage section 125 to the fish counting unit 134 and the output unit 14. The same fish identification unit 133 may be electrically connected to the fish counting unit 134, and the fish counting unit 134 to the fish position information acquisition unit 131 and the output unit 14. For example, the fish counting device 20 may cause the data storage unit 12 to store the measurement images and may output the stored measurement images to the data processing unit 13 to perform data processing. Alternatively, the fish counting device 20 may input the measurement images to the data processing unit 13 to perform data processing.

It is preferred that, in the present embodiment, the fish position information may include information on the same fish in addition to coordinates on the coordinate plane, an area, or the like as mentioned above. The information on the same fish can be, for example, associated with the fish position information (Iₘ). Moreover, in the present embodiment, the data processing unit 13 preferably process, over time, the n measurement images acquired over time. The processing over time can be, for example, processing in order of acquiring the measurement images.

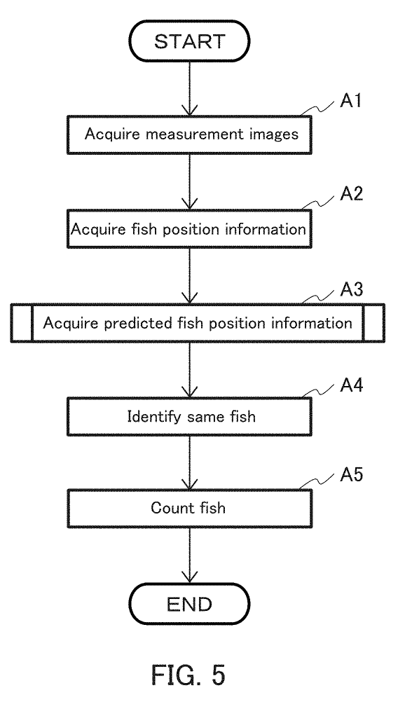

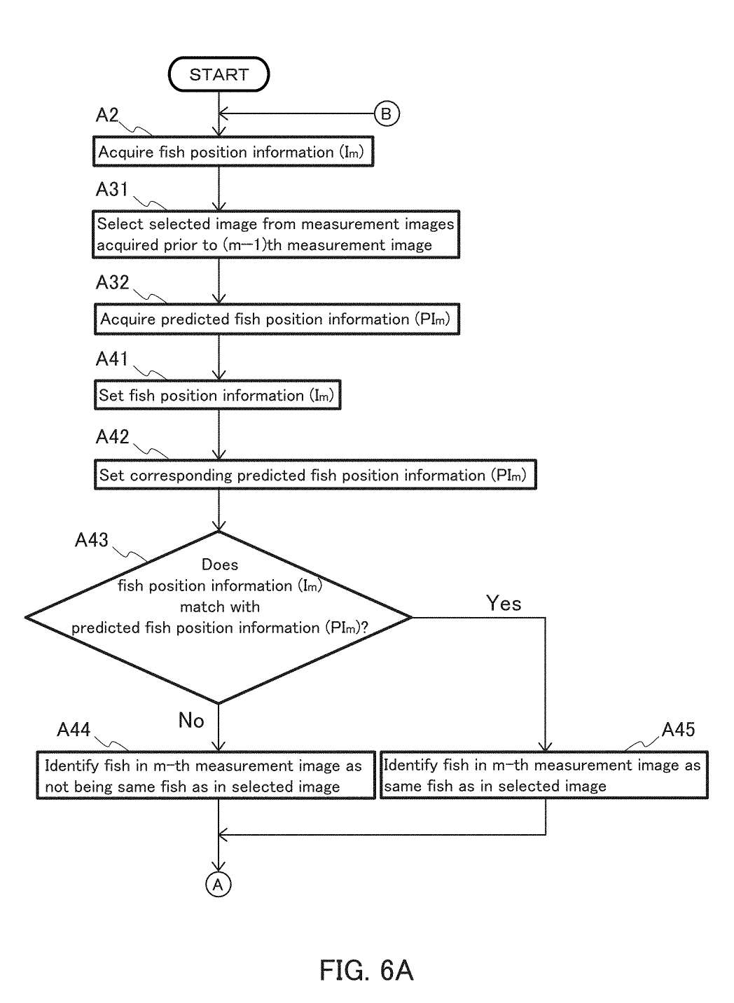

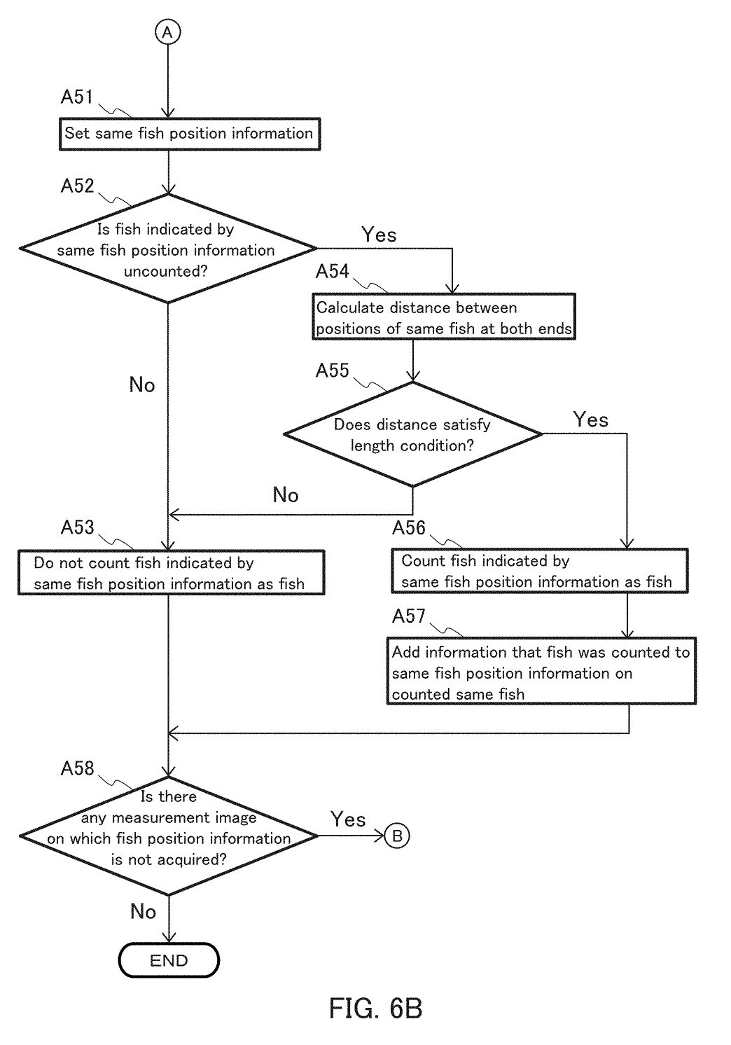

The following describes the fish counting method according to the present embodiment with reference to the flowcharts of FIGS. 5, 6A, and 6B. The fish counting method according to the present embodiment is performed as follows using the fish counting device of FIG. 4, for example. The fish counting method according to the present embodiment includes a step A1 (measurement image acquisition), a step A2 (fish position information acquisition), a step A3 (predicted fish position information acquisition), a step A4 (same fish identification), and a step A5 (fish counting). In FIGS. 5, 6A, and 6B, identical steps to those in FIG. 2 are denoted by identical reference numerals.

The steps A1, A2, A3, and A41 to A45 in FIG. 6A can be performed in the same manner as in the first embodiment and can be specifically performed in accordance with the flowchart of FIG. 3.

(A5) Fish Counting

The same fish position information on the fish identified as the same fish in the steps A41 to A45 (same fish identification) (A51) are set. Whether the fish indicated by the set same fish position information has been uncounted is then determined (A52). If No, i.e., if the fish has been counted, the fish is not counted (A53). If Yes, i.e., if the fish has been uncounted, a distance between fish at both ends of the measurement images, indicated by the same fish position information, e.g., a distance between the positions of the same fish at both ends on the coordinate plane is calculated (A54). Whether the distance satisfies a length condition is then determined (A55). If No, i.e., if the distance does not satisfy the length condition, the fish indicated by the same fish position information is not counted (A53). If Yes, i.e., if the distance satisfies the length condition, the fish indicated by the same fish position information is counted (A56). Information that the fish has been counted is then added to the same fish position information on the counted same fish (A57).

Thereafter, the presence or absence of a measurement image on which fish position information has not been acquired is checked (A58). If Yes, i.e., if there is a measurement image on which fish position information has not been acquired, the operation is performed from the step A2. At that time, predicted fish position information that has not been acquired (e.g., predicted fish position information (PIₘ₊₁)) is acquired in the step A3, whether the corresponding fish position information (e.g., fish position information (Iₘ₊₄)) is the same as the predicted fish position information (PIₘ₊₁) is identified in the step A4, and the fish indicated by the same fish position information is counted in the step A5. If No, i.e., if there is no measurement image on which fish position information has not been acquired, the process is finished. In the present embodiment, the fish is counted on the basis of the distance between the positions of the same fish at both ends of the measurement images. The present invention, however, is not limited thereto, and for example, the fish may be counted on the basis of the number of measurement images including the same fish.

The fish counting device 20 according to the present embodiment may further include an input unit. The input unit in the fish counting device 20 according to the present embodiment may be connected to, for example, the fish counting unit 134. With the input unit connected to the fish counting unit 134, information on start and stop of counting fish is input to the fish counting unit 134, for example.

The fish counting device according to the present embodiment may further include a fish movement line calculation unit to calculate, by the fish movement line calculation unit, a movement line of the same fish as a track of movement of the same fish on the basis of the same fish position information identified by the same fish identification device and count, by the fish counting unit, the fish on the basis of the fish movement line to obtain a fish count. The fish counting method according to the present embodiment may further include a fish movement line calculation step to calculate, in the fish movement line calculation step, a movement line of the same fish as a track of movement of the same fish on the basis of the same fish position information identified by the same fish identification method and count, in the fish counting step, the fish on the basis of the fish movement line to obtain a fish count. The movement line can be calculated by connecting the positions of the same fish indicated by the same fish position information, for example. The counting of the movement line can be performed by obtaining the number of movement lines, for example.

The fish counting device according to the present embodiment may further include a notification unit to notify, when the fish count satisfies a fish count condition, the satisfaction of the fish count condition by the notification unit. The fish counting method according to the present embodiment may further include a notifying step to notify, when the fish count satisfies the fish count condition, the satisfaction of the fish count condition in the notifying step. The fish count condition may be, for example, the number of fish at which the notification is performed. The fish count condition may be, for example, the number of fish set in advance, set in use, or set during use. The notification can be, for example notification by light or sound. In the former case, examples of the notification unit include Light Emitting Diode (LED), Organic Light Emitting diode (OLED), and a laser diode. In the latter case, examples of the notification unit include a speaker and a beeper.

### Third Embodiment

The third embodiment relates to the fish counting method of the present invention.

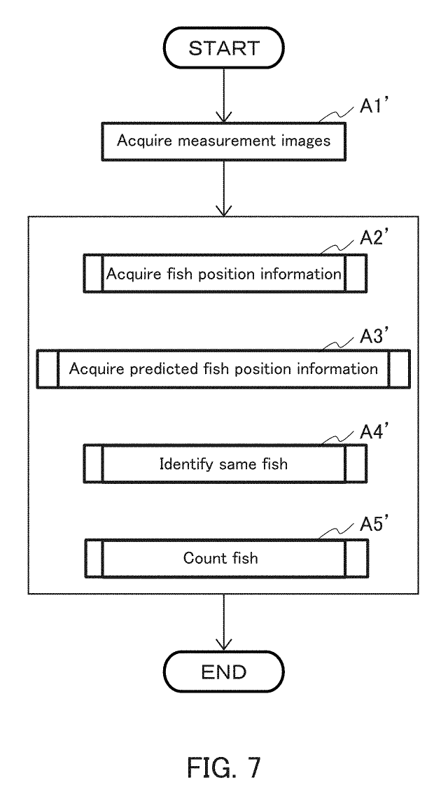

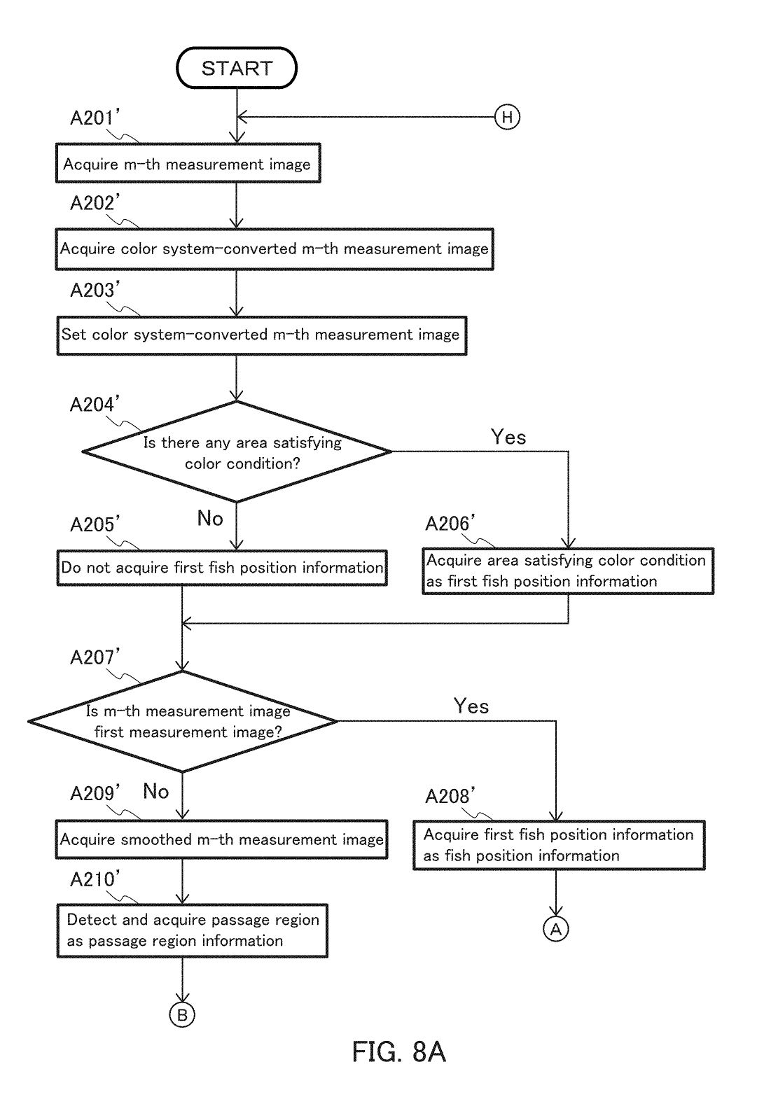

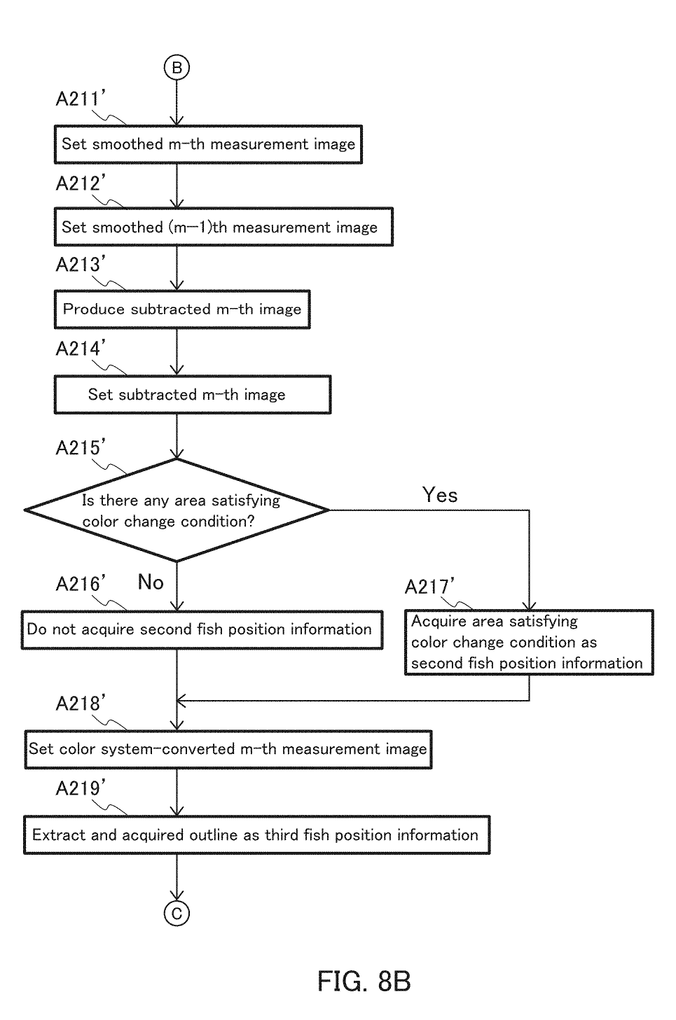

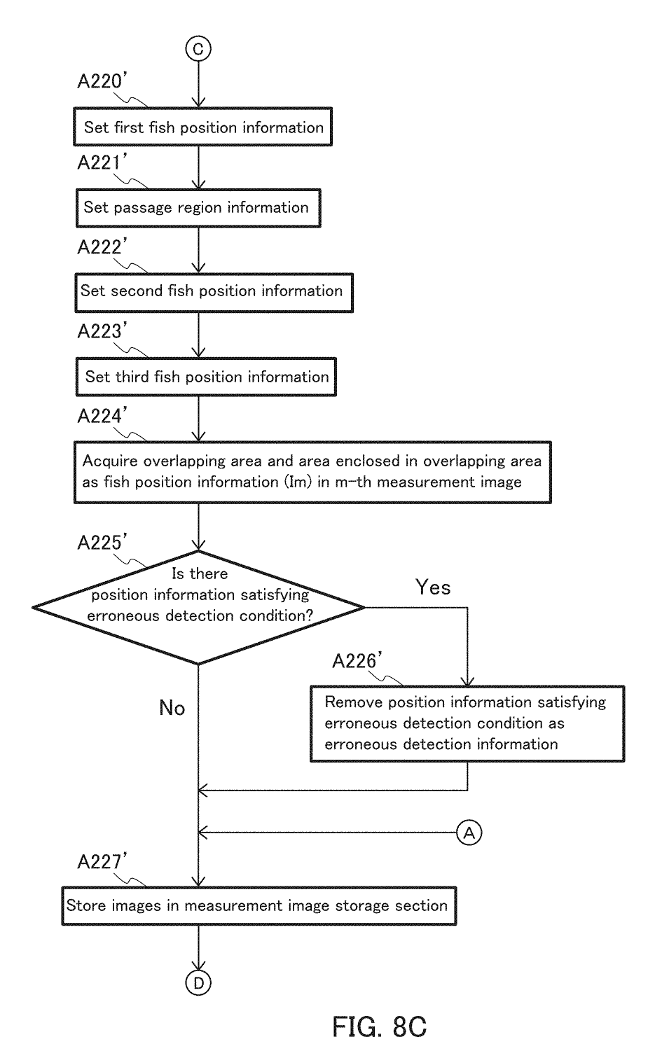

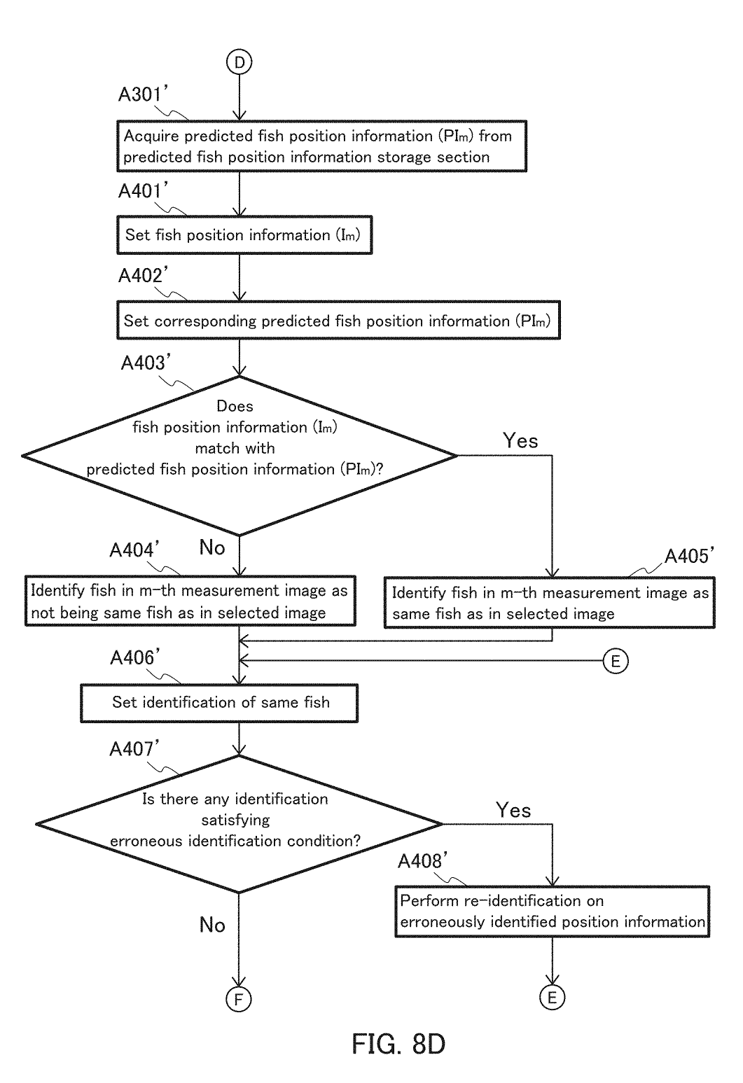

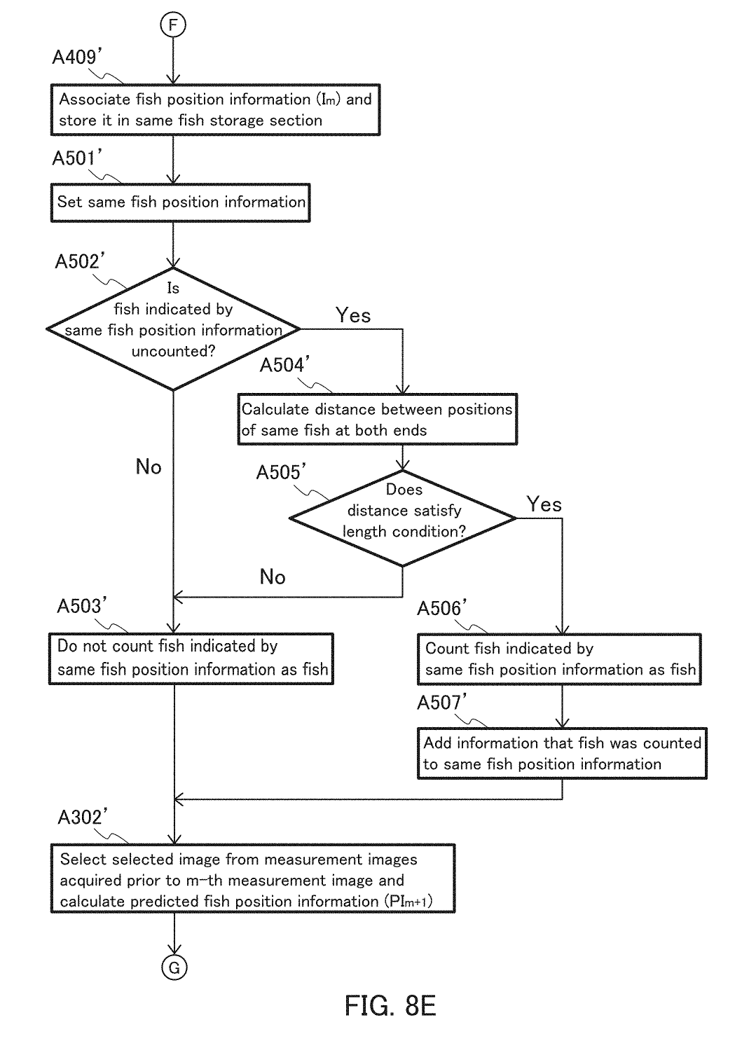

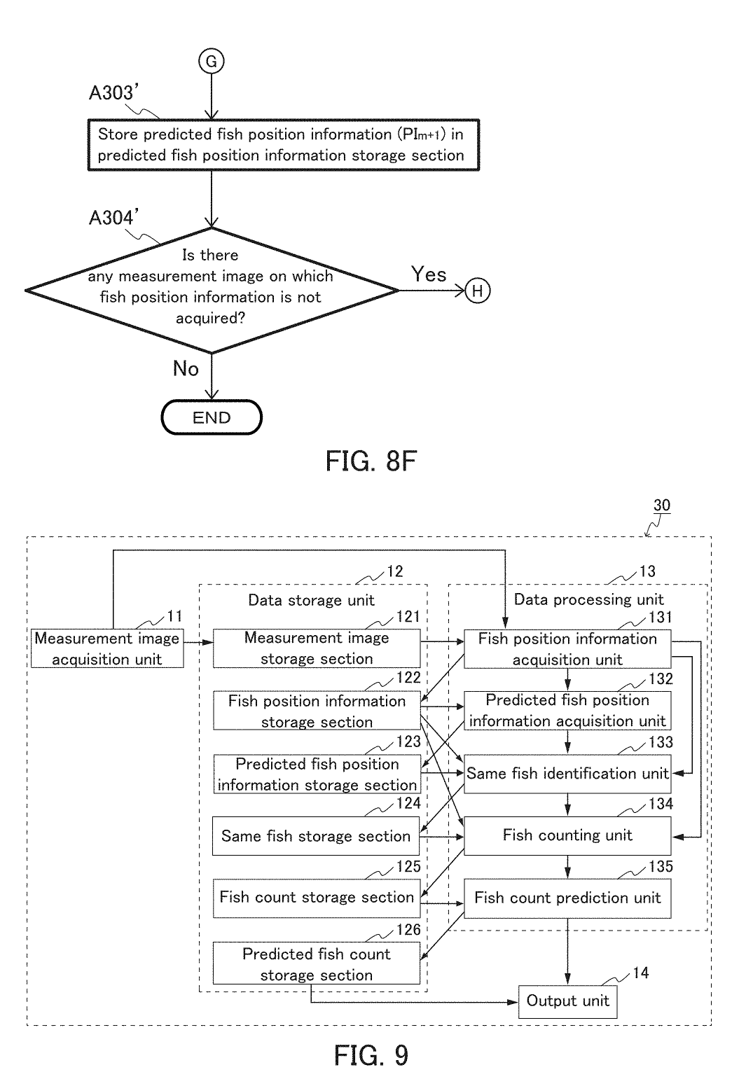

The third embodiment describes the fish counting method of the present invention in more detail. FIGS. 7 and 8A to 8F are flowcharts of the fish counting method according to the present embodiment.

The fish counting method according to the present embodiment is performed as follows using the fish counting device of FIG. 4, for example. The fish counting method according to the present embodiment includes a step A1′ (measurement image acquisition), a step A2′ (fish position information acquisition), a step A3′ (predicted fish position information acquisition), a step A4′ (same fish identification), and a step A5′ (fish counting).

(A1′) Measurement Image Acquisition

In a step A1′, n measurement images of a region to be measured in a passage region where a fluid containing fish passes through are acquired over time. The measurement images are then stored in the measurement image storage section 121. In the present embodiment, the measurement images are taken on a white background and are represented by the RGB color system. The passage region is rectangular. The following describes the process of counting fish in the m-th measurement image among the n measurement images, and the same process can be applied to the other measurement images.

(A2′) Fish Position Information Acquisition

The m-th measurement image is acquired from the measurement image storage section 121 (A201′). At that time, for example, in order to increase the speed of processing and smooth the measurement image, the measurement image in a reduced size is acquired. The RGB color system of the m-th measurement image is then converted into the L*a*b color system, a color system-converted m-th measurement image is acquired (A202′). The color system-converted m-th measurement image is then set (A203′). Whether the color system-converted m-th measurement image has an area satisfying a color condition is determined (A204′). The color condition is that the L-values of pixels in the color system-converted m-th measurement image are lower than a predetermined L-value. If No, i.e., if there is no area satisfying the color condition, first fish position information is not acquired (A205′). If Yes, i.e., if there is an area satisfying the color condition, the area satisfying the color condition is acquired as first fish position information (A206′). Whether the m-th measurement image is the first measurement image is then determined. If Yes, i.e., if m is 1, first position information is acquired as a fish position information for the first measurement image, and the process proceeds to the step A227′. If No, i.e., if m is not 1, the process proceeds to the step A209′. In the step A209′, a smoothed m-th measurement image is produced from the color system-converted m-th measurement image and is acquired. The smoothed m-th measurement image can be produced by processing the L-values of the color system-converted m-th measurement image with a box filter. Furthermore, the passage region which is a straight line in the color system-converted m-th measurement image is detected using a combination of hough transformation and a Sobel filter. The upper ¼ and the lower ¼ of color system-converted m-th measurement image is subjected to the detection of the passage region to reduce an erroneous detection. The detection of the straight line is performed by detecting a passage region having the maximum sum of edge intensities calculated with a Sober filter. The passage region is then acquired as passage region information (A210′).

The smoothed m-th measurement image is then set (A211′), and the smoothed (m−1)th measurement image is set (A212′). An m-th subtracted image that is a difference between the smoothed m-th measurement image and the smoothed (m−1)th measurement image is then produced (A213′) and is set (A214′). Whether there is an area satisfying a color change condition in the m-th subtracted image is determined (A215′). The color change condition is that the L-values of pixels in the m-th subtracted image are lower than a predetermined L-value. If No, i.e., if there is no area satisfying the color change condition, second fish position information is not acquired (A216′). If Yes, i.e., if there is an area satisfying the color change condition, the area is acquired as second fish position information (A217′). The color system-converted m-th measurement image is then set (A218′). An outline(s) is then extracted from the color system-converted m-th measurement image with a Canny filter and is acquired as third fish position information (A219′).

The first fish position information, the passage region information, the second fish position information, and the third fish position information are then set (A220′ to A223′). An overlapping area(s) and an area(s) enclosed in the overlapping area (s) indicated by these pieces of information are then acquired as fish position information (Iₘ) in the m-th measurement image (A224′). Whether there is position information satisfying an erroneous detection condition in the fish position information (Iₘ) in the m-th measurement image is determined (A225′). The erroneous detection condition is as mentioned above. If Yes, i.e., if there is position information satisfying an erroneous detection condition in the fish position information (Iₘ), the position information is removed as erroneous information from the fish position information (Iₘ) i, and the process proceeds to the step A226′. If No, i.e., if there is no position information satisfying an erroneous detection condition in the fish position information (Iₘ), the process proceeds to the step A227′. In the step A227′, images such as the measurement images, the color system-converted measurement images, and the smoothed measurement images are stored in the measurement image storage section 121. To improve the accuracy of detecting fish on the basis of the subtracted images, information on the color system of the area indicated by the fish position information (Iₘ) in each of the measurement images is not stored when the measurement images are stored.

(A3′) Predicted Fish Position Information Acquisition, (A4′) Same Fish Identification, and (A5′) Fish Counting

The predicted fish position information (PIₘ) is acquired from the predicted fish position information storage section 123 (A301′), and the fish position information (Iₘ) and the predicted fish position information (PIₘ) are set (A302′ and A303′). Whether the fish position information (Iₘ) matches with the predicted fish position information (PIₘ) is then determined. If No, i.e., if the fish position information (Iₘ) does not match with the predicted fish position information (PIₘ), the fish in the m-th measurement image is identified as not being the same fish as in the selected image used to acquire the predicted fish position information (PIₘ) (A404′). If Yes, i.e., if the fish position information (Iₘ) matches with the predicted fish position information (PIₘ), the fish in the m-th measurement image is identified as the same fish as in the selected image (A405′). The identification of the same fish is set (A406′), and whether the identification satisfies an erroneous identification condition is determined (A407′). If Yes, i.e., if the identification satisfies the erroneous identification condition, re-identification of identifying whether the fish in the m-th measurement image is the same fish as in the selected image other than the fish that have been erroneously identified as the same fish on the basis of the fish position information (Iₘ) and the predicted fish position information (PIₘ) is performed in the same manner as in the steps A403′ to A405′ (A408′). Whether the obtained identification is an erroneous identification is determined in the same manner as in the steps A406′ and A407′. These processes are performed repeatedly until the identification satisfying the erroneous identification condition is not present. If No, the process proceeds to the step A409′. In the step A409′, the fish position information (Iₘ) is associated for the same fish and is stored in the same fish storage section 124.

The steps A501′ to A507′ can be performed in the same manner as in the second embodiment and is specifically performed in the same manner as in the steps A51 to A57. The measurement images acquired prior to the m-th measurement image, i.e., the first measurement image to the m-th measurement image are used as selected images, and predicted fish position information (PIₘ₊₁) in the (m+1)th measurement image (A302′) is acquired. The predicted fish position information (PIₘ₊₁) is then stored in the predicted fish position information storage section 123 (A303′).

The presence or absence of a measurement image on which fish position information has not been acquired is checked (A304′). If Yes, i.e., if there is a (m+1)th measurement image that is a measurement image on which fish position information has not been acquired, the (m+1)th measurement image is subjected to the same process from the step A2′. If No, i.e., if there is no (m+1)th measurement image, the process is finished.

### Fourth Embodiment

The fourth embodiment relates to the mobile terminal for counting fish of the present invention.

The mobile terminal for counting fish according to the present embodiment can accurately detect the same fish, for example. The mobile terminal for counting fish according to the present embodiment thus can accurately count fish, for example. As the mobile terminal for counting fish according to the present embodiment, a camera-equipped portable terminal can be used for example, and a cost thus can be reduced. The mobile terminal for counting fish according to the present embodiment can be described with reference to the descriptions of the same fish identification device and the same fish identification method, for example.

The mobile terminal for counting fish according to the present embodiment includes a measurement image acquisition unit, a fish position information acquisition unit, a predicted fish position information acquisition unit, a same fish identification unit, a fish counting unit, and a display unit. The display unit may be electrically connected to one or more or all of the measurement image acquisition unit, the fish position information acquisition unit, the predicted fish position information acquisition unit, the same fish identification unit, and the fish counting unit, for example. The display unit may be electrically connected to storage sections corresponding to the respective units.

The display unit can be, for example, the above-mentioned monitor. The display unit displays, for example, the measurement images acquired by the measurement image acquisition unit, fish position information acquired by the fish position information acquisition unit, predicted fish position information acquired by the predicted fish position information acquisition unit, the information on the same fish identified by the same fish identification unit, and information on a fish count obtained by the fish counting unit. The display unit may display the information acquired in the first modification to the seventh modification. The number of pieces of information to be displayed is not limited to particular values and may be, for example, one or more or all.

The mobile terminal for counting fish according to the present embodiment may not include the fish counting unit, for example. In this case, the mobile terminal for counting fish according to the present embodiment can also be referred to as, for example, a mobile terminal for identifying the same fish. The mobile terminal for counting fish according to the present embodiment may include, for example, a fish count prediction unit described below. In this case, the mobile terminal for counting fish according to the present embodiment can also be referred to as, for example, a mobile terminal for predicting a fish count.

### Fifth Embodiment

The fifth embodiment relates to the fish count prediction device and the fish count prediction method of the present invention.

The fish count prediction device and the fish count prediction method according to the present embodiment can accurately detect the same fish, for example. The fish count prediction device and the fish count prediction method according to the present embodiment thus can accurately predict fish, for example. The fish count prediction device and the fish count prediction method according to the present embodiment obtain a fish count from each of the k measurement images acquired within the time set in advance and predict a total fish count from the obtained fish count. The fish count prediction device and the fish count prediction method according to the present embodiment thus allows a device including a data processing unit to predict a fish count, and a fish count thus can be easily predicted, for example. Moreover, as the fish count prediction device according to the present embodiment, a camera-equipped portable terminal can be used, for example, and a cost thus can be reduced. The fish count prediction device and the fish count prediction method according to the present embodiment can be described with reference to the descriptions of the same fish identification device and the same fish identification method, for example.

FIG. 9 is a block diagram of the fish count prediction device according to the present embodiment. As shown in FIG. 9, the fish count prediction device 30 according to the present embodiment includes a measurement image acquisition unit 11, a measurement image storage section 121, a fish position information storage section 122, a predicted fish position information storage section 123, a same fish storage section 124, a fish count storage section 125, a predicted fish count storage section 126, a fish position information acquisition unit 131, a predicted fish position information acquisition unit 132, a same fish identification unit 133, a fish counting unit 134, a fish count prediction unit 135, and an output unit 14. The measurement image storage section 121, the fish position information storage section 122, the predicted fish position information storage section 123, the same fish storage section 124, the fish count storage section 125, and the predicted fish count storage section 126 may be incorporated in a data storage unit 12 that is hardware as shown in FIG. 9, for example. The fish position information acquisition unit 131, the predicted fish position information acquisition unit 132, the same fish identification unit 133, the fish counting unit 134, and the fish count prediction unit 135 may be incorporated in a data processing unit (data processing device) 13 that is hardware as shown in FIG. 9 or may be software or hardware incorporating the software, for example. The data processing unit 13 may include, for example, CPU. The measurement image storage section 121, the fish position information storage section 122, the predicted fish position information storage section 123, the same fish storage section 124, the fish count storage section 125, the predicted fish count storage section 126, and the output unit 14 are optional components, and the fish count prediction device 30 may or may not include the optional components or may include one or more of the optional components.

The fish count storage section 125 is further electrically connected to the fish count prediction unit 135, and the predicted fish count storage section 126 to the fish count prediction unit 135 and the output unit 14. The fish counting unit 134 may be electrically connected to the fish count prediction unit 135, and the fish count prediction unit 135 to the output unit 14. For example, in the fish count prediction device 30, the measurement images are stored in the data storage unit 12, and the stored measurement images are output to the data processing unit 13 to perform data processing. Alternatively, in the fish count prediction device 30, the measurement images may be input to the data processing unit 13 to perform data processing.

The measurement image acquisition unit 11 (hereinafter also merely referred to as the “predicted measurement image acquisition unit”) acquires, within time set in advance, k measurement images of a region to be measured in a passage region where a fluid containing fish passes through. The time set in advance is not limited to particular times and can be determined, as appropriate, on the basis of the volume of the fluid and the density of fish in the fluid, for example. The range of the “k” is, for example, a range of 1 to n that is any positive integer and is, preferably a positive integer that is smaller than n. For example, other than this, the measurement image acquisition unit 11 is the same as that according to the first embodiment and can be described with reference to the description of the measurement image acquisition unit 11 according to the first embodiment.

The fish count prediction unit 135 predicts a fish count of fish that passed through the passage region on the basis of the fish count obtained from the k measurement images acquired within time set in advance by the fish counting device, i.e., the fish counting unit 134 or the like, the time set in advance, and the total time required for the fluid containing the fish to pass through the passage region. In the present embodiment, the “m” is, for example, any positive integer in the range from 1 to k and is preferably a positive integer smaller than k.

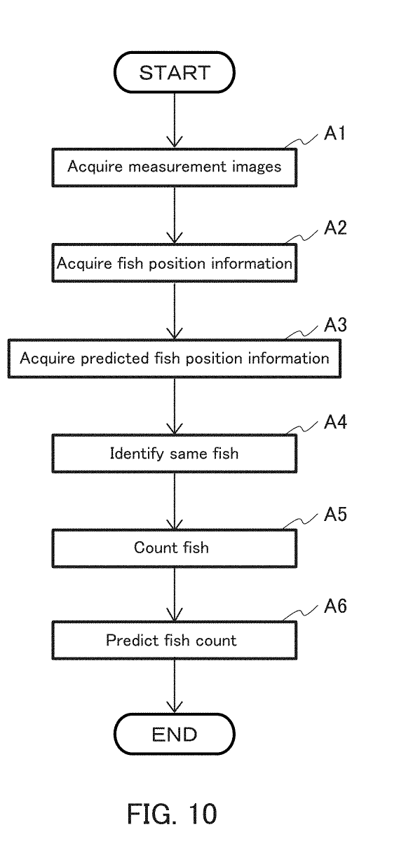

FIG. 10 is a flowchart showing the fish count prediction method according to the present embodiment. The fish count prediction method according to the present embodiment is performed as follows using the fish count prediction device of FIG. 9, for example. As shown in FIG. 10, the fish counting method according to the present embodiment includes a step A1 (measurement image acquisition, also referred to as “predicted measurement image acquisition”), a step A2 (fish position information acquisition), a step A3 (predicted fish position information acquisition), a step A4 (same fish identification), a step A5 (fish counting), and a step A6 (fish count prediction). In the fish count prediction method according to the present embodiment, the steps A2, A3, A4, and A5 are the same as those in the fish counting method according to the second embodiment and can be described with reference to the descriptions of those.

(A1) Measurement Image Acquisition

In the step A1, k measurement images of a region to be measured in a passage region where a fluid containing fish passes through within time set in advance are acquired. For acquisition of the measurement images by an imaging unit, images of the passage region where a fluid containing fish passes through are taken within time set in advance and are acquired. For acquisition of the measurement images by a data storage unit, k measurement images taken within time set in advance are read out and acquired among measurement images stored in the data storage unit.

The steps A2 to A5 are then performed in the same manner as in the fish counting method according to the second embodiment.

(A6) Fish Count Prediction

In the step A6, a fish count of fish passed through the passage region is predicted on the basis of the fish count (C) obtained by counting the fish in the k measurement images acquired within time set in advance, the time (S) set in advance, and total time (T) required for the fluid containing the fish to pass through. The predicted fish count (P) can be calculated by the following formula (1), for example.

P=C×(T/S) (1)

P: predicted fish count

C: obtained fish count

S: time set in advance

T: total time required for fluid containing fish to pass through

### Sixth Embodiment

The present embodiment relates to operation screens (interfaces) and operations of the same fish identification device, the fish counting device, the mobile terminal for counting fish, and the fish count prediction device.

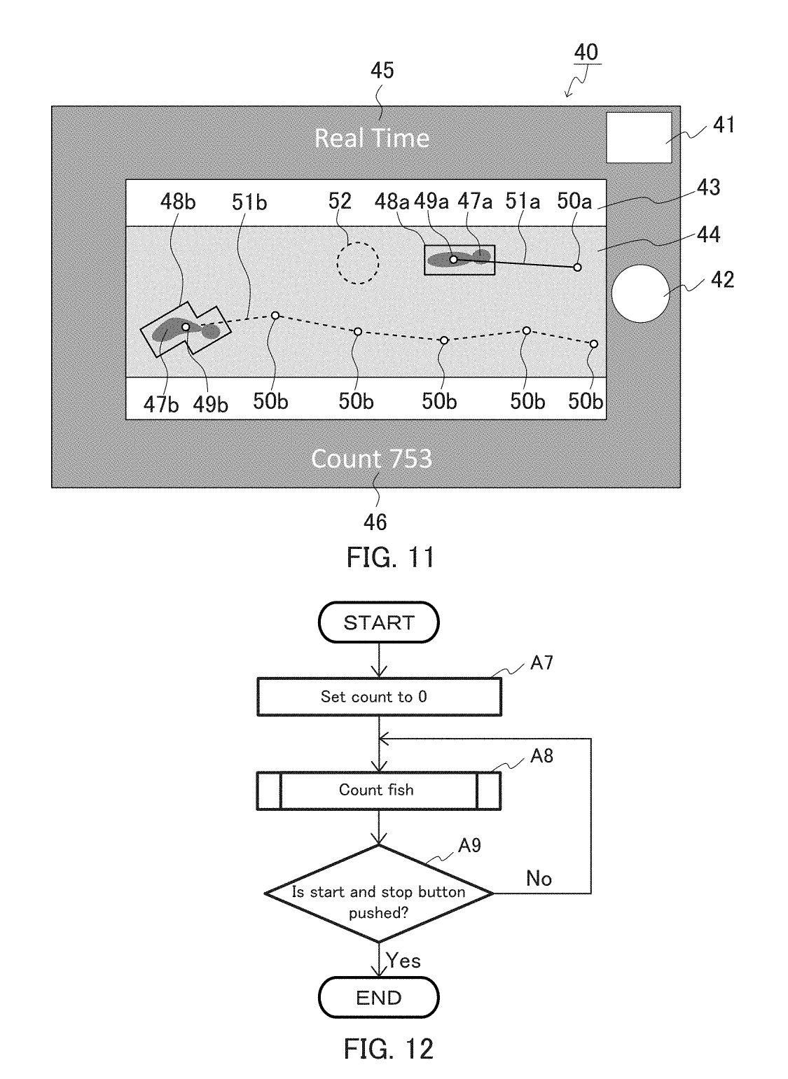

The operation screens and the operations of the fish counting device and the mobile terminal for counting fish are described below with reference to FIGS. 11 and 12. The operation screen and the operation of the mobile terminal for counting fish are described with reference to the descriptions of the operation screen and the operation of the fish counting device.

FIG. 11 shows an operation screen of the fish counting device. As shown in FIG. 11, an operation screen 40 of the fish counting device according to the present embodiment includes an operation mode change button 41, a start and stop button 42, a measurement image 43, a region to be measured 44, an operation mode display 45, and a fish count display 46. In the present embodiment, the measurement image 43 includes fish 47a and 47b in a region to be measured 44. The operation screen 40 displays fish displays 48a and 48b, current fish position information displays 49a and 49b, past fish position information displays 50a and 50b, fish movement line displays 51a and 51b, and a predicted position information display 52. The fish 47a indicates an uncounted fish, and the fish 47b indicates a counted fish.

With the operation mode change button 41, an operation mode of the fish counting device can be changed, for example, between a real-time mode of acquiring a measurement image 43 from the imaging unit and a recording mode of reading and acquiring the measurement image 43 out of the data storage unit.

With the start and stop button 42, counting of the fish is started and stopped. For the real-time mode as the operation mode, taking images by the imaging unit can be started with the start and stop button 42 at the time when counting of the fish is started, and taking images by the imaging unit can be stopped with the same at the time when counting of the fish is stopped. The start and the stop are performed with one start and stop button in the present embodiment and however may be performed separately with different buttons. The start and stop button 42 may have, for example, a function of pausing.

The operation mode display 45 displays an operation mode of the fish counting device.

The fish count display 46 displays a fish count obtained by counting the fish using the fish counting device.

Each of the fish displays 48a and 48b is a display indicating an area occupied by each fish in the measurement image displayed on the operation screen 40. The position of each fish may be displayed by providing a display frame surrounding each fish or displaying an area of each fish with a different color, for example. In the former case, the shape of the display frame may be any shape such as a rectangular shape, a circular shape, or a square shape.

Each of the current fish position information displays 49a and 49b indicates the position of each fish in the measurement image displayed on the operation screen 40. Examples of the position of each fish include an average of positions of body parts of each fish, the position of the center of gravity of each fish, and the center of each fish display.

Each of the past fish position information displays 50a and 50b indicates the position of each fish in a measurement image acquired by the fish counting device prior to the measurement image displayed on the operation screen 40. The position of each fish is, for example, the same as described for the current fish position information displays 49a and 49b.

Each of the fish movement line displays 51a and 51b indicates the track of movement of each of the fish 47a and the fish 47b. The movement line can be displayed by, for example, connecting the current fish position information display and the past fish position information displays for the same fish on the basis of the fish position information acquired by the fish counting device. In the fish counting device including a fish movement line calculation unit, the movement line may be calculated by the fish movement line calculation unit.

The predicted position information display 52 indicates a predicted fish position in a measurement image acquired next to the measurement image displayed on the operation screen 40. The predicted fish position can be displayed on the basis of the predicted fish position information acquired by the fish counting device. Specifically, when the measurement image displayed on the operation screen 40 is a (m−1)th measurement image, the predicted fish position information (PIₘ) in the m-th measurement image is displayed as the predicted fish position, for example.

The displays on the operation screen 40 may be displayed in the same manner as in the fish displays 48a and 48b or may be displayed in the different manner according to whether a counted fish or an uncounted fish as in the fish movement line displays 51a and 51b, for example. In the latter case, displays in the different manners may be, for example, displays indicted by different colors, different kinds of line or the like.

An operation of the fish counting device with the start and stop button 42 is described below with reference to FIG. 12. FIG. 12 is a flowchart of an operation of the fish counting device. As shown in FIG. 12, the operation of the present embodiment includes a step A7 (count reset), a step A8 (fish counting), and a step A9 (stop determination).

(A7) Count Reset

When an operation of the start of counting of the fish is performed with the start and stop button 42, the fish count display 46 is set to display 0 in the step A7.

(A8) Fish Counting

In the step A8, fish passed through a region to be measured 44 are counted by the fish counting method.

(A9) Stop Determination

In the step A9, whether an operation of the stop of counting of the fish is performed with the start and stop button 42 is determined. If No, if it is determined that the stop operation of counting of the fish is not performed, the step is returned to the step A8 to continuously count the fish. If Yes, if it is determined that the stop operation of counting of the fish is performed, the counting of the fish is stopped.

The operation screen and the operation of the same fish identification device are described below. The operation screen of the same fish identification device according to the present embodiment is the same as the operation screen 40 of the fish counting device except that the same fish identification device does not display a fish count display 46 and can be described with reference to the description of the operation screen 40. The operation of the same fish identification device according to the present embodiment is the same as that of the fish counting device except that the step A7 is not performed, and the same fish identification method is performed in the step A8 as substitute for the fish counting method and can be described with reference to the description of the operation of the fish counting device.

The operation screen and the operation of the fish count prediction device are described below. The operation screen of the fish count prediction device according to the present embodiment is the same as the operation screen 40 of the fish counting device except that the operation screen displays a predicted fish count as a substitute for the fish count display 46 and can be described with reference to the description of the operation screen 40. The operation of the fish count prediction device according to the present embodiment is the same as that of the fish counting device except that the fish count prediction method is performed in the step A8 as substitute for the fish counting method and can be described with reference to the description of the operation of the fish counting device.

### Seventh Embodiment

A program according to the present embodiment is a program configured to execute the same fish identification method, the fish counting method, or the fish count prediction method on a computer. The program according to the present embodiment may be, for example, recorded on a computer-readable recording medium. The recording medium is not limited to particular media, and examples thereof include a random access memory (RAM), a read-only memory (RAM), a hard disc (HD), an optical disc, and a floppy (registered trademark) disc (FD).

### Eighth Embodiment

The Eighth embodiment relates to the same fish identification system of the present invention.

The same fish identification system according to the present embodiment can easily identify the same fish, for example. The same fish identification system according to the present embodiment allows the measurement image acquisition unit and the output unit to be installed at the site, the server and the like to be installed at another place, and can determine that same fish online. Thus, a large space for the units is not required, and the units can be easily maintained. Moreover, the units installed apart from one another can be controlled centrally and remotely operated. The same fish identification system of the present invention can be described with reference to the descriptions of the same fish identification device and the same fish identification method, for example.

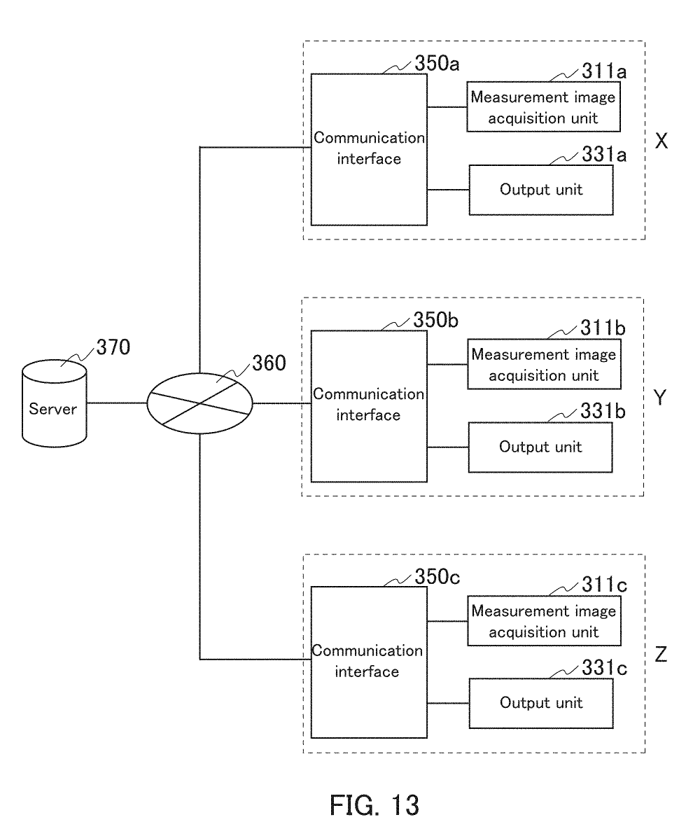

FIG. 13 shows a configuration of the same fish identification system according to the present embodiment using the same fish identification device of the present invention. As shown in FIG. 13, the same fish identification system according to the present embodiment includes measurement image acquisition units 311a, 311b, and 311c, output units 331a, 331b, and 331c, communication interfaces 350a, 350b, and 350c, and a server 370. The measurement image acquisition unit 311a and the output unit 331a are connected to the communication interface 350a. The measurement image acquisition unit 311a, the output unit 331a, and the communication interface 350a are installed in a place X. The measurement image acquisition unit 311b and the output unit 331b are connected to the communication interface 350b. The measurement image acquisition unit 311b, the output unit 331b, and the communication interface 350b are installed in a place Y. The measurement image acquisition unit 311c and the output unit 331c are connected to the communication interface 350c. The measurement image acquisition unit 311c, the output unit 331c, and the communication interface 350c are installed in a place Z. The communication interfaces 350a, 350b, and 350c and the server 370 are connected via a line network 360.

The fish position information acquisition unit, the predicted fish position information acquisition unit, and the same fish identification unit in this same fish identification system are stored in the server 370. For example, n measurement images acquired using the measurement image acquisition unit 311a in the place X are sent to the server 370, and whether the fish are the same fish or not is identified in the server 370. The identification of the same fish or not is output from the output unit 331a.

The same fish identification system according to the present embodiment may be compatible with a combination of the above-mentioned embodiments and modifications. The same fish identification system according to the present embodiment may be compatible with cloud computing. Moreover, in the same fish identification system according to the present embodiment, the communication interfaces 350a, 350b, and 350c and the server 370 may be connected via a radio line.

### Ninth Embodiment

The ninth embodiment relates to the fish counting system of the present invention.

The fish counting system according to the ninth embodiment can accurately detect the same fish, for example. The fish counting system according to the ninth embodiment thus can accurately count fish. The fish counting system according to the ninth embodiment allows the measurement image acquisition unit and the output unit to be installed at the site, the server and the like to be installed at another place, and fish to be counted online. Thus, a large space for the units is not required, and the units can be easily maintained. Moreover, the units installed apart from one another can be controlled centrally and remotely operated. The fish counting system of the present invention can be described with reference to the descriptions of the same fish identification device and the same fish identification method, for example.

The fish counting system according to the present embodiment is obtained by further storing a fish counting unit in the server 370 of the same fish identification system according to the ninth embodiment. The fish counting system sends n measurement images acquired using the measurement image acquisition unit 311a in the place X to the server 370, and fish are counted in the server 370 to obtain a fish count. The obtained fish count is then output with the output unit 311a. Other than this, the fish counting system according to the ninth embodiment can be described with reference to the description of the same fish identification system according to the ninth embodiment.

### Tenth Embodiment

The tenth embodiment relates to the fish count prediction system of the present invention.

The fish count prediction system according to the present embodiment can accurately detect the same fish. The fish count prediction system according to the present embodiment thus can accurately predict fish, for example. The fish count prediction system according to the present embodiment obtains a fish count from each of the k measurement images acquired within the time set in advance and predicts a total fish count from the obtained fish count. The fish count prediction system according to the present embodiment thus allows a server including a data processing unit to predict a fish count and can easily predict a fish count. The fish counting system according to the present embodiment allows the measurement image acquisition unit and the output unit to be installed at the site, the server and the like to be installed at another place, and fish to be counted online. Thus, a large space for the units is not required, and the units can be easily maintained. Moreover, the units installed apart from one another can be controlled centrally and remotely operated. The fish count prediction system of the present invention can be described with reference to the descriptions of the same fish identification device and the same fish identification method, for example.

In the fish counting system according to the present embodiment is obtained by further storing a fish counting unit and a fish count prediction unit in the server 370 of the same fish identification system according to the ninth embodiment. The fish counting system then sends k measurement images acquired in the predetermined time period using the measurement image acquisition unit (predicted measurement image acquisition unit) 311a in the place X to the server 370, and the server 370 predicts a fish count. The predicted fish count is then output from the output unit 331a. Other than this, the fish prediction system according to the present embodiment can be described with reference to the description of the same fish identification system according to the ninth embodiment.

The present invention is described above with reference to the exemplary embodiments. The present invention, however, is by no means limited thereto. Various changes and modifications that may become apparent to those skilled in the art may be made in the configuration and specifics of the present invention without departing from the scope of the present invention.

This application is based upon and claims the benefit of priority from Japanese patent application No. 2015-046118, filed on Mar. 9, 2015, the disclosure of which is incorporated herein its entirety by reference.

### INDUSTRIAL APPLICABILITY

The present invention can easily identify the same fish. The present invention thus can identify, for example, the same fish in the presence of a plurality of fish in each of the measurement images and therefore can prevent overlapping counting and can efficiently count fish. The present invention is therefore really useful in, for example, an aquaculture field and a fishery field.

### EXPLANATION OF REFERENCE NUMERALS

10 same fish identification device
11 measurement image acquisition unit
12 data storage unit
121 measurement image storage section
122 fish position information storage section
123 predicted fish position information storage section

124 same fish storage section
125 fish count storage section
126 predicted fish count storage section
13 data processing unit
131 fish position information acquisition unit
132 predicted fish position information acquisition unit
133 same fish identification unit
134 fish counting unit
135 fish count prediction unit
14 output unit
20 fish counting device
30 fish count prediction device
40 operation screen
41 operation mode change button
42 start and stop button
43 measurement image
44 region to be measured
45 operation mode display
46 fish count display
47a, 47b fish
48a, 48b fish display
49a, 49b current fish position information display
50a, 50b past fish position information display
51a, 51b fish movement line display
52 predicted position information display
311a, 311b, 311c measurement image acquisition unit
331a, 331b, 331c output unit
350a, 350b, 350c communication interface
360 line network
370 server

What is claimed is:

1. A same fish identification device comprising at least one processor configured to:
acquire, over time, n measurement images of a region to be measured in a passage region where a fluid containing at least one fish passes through,
acquire fish position information in the n measurement images,
select at least one selected image from the measurement images acquired prior to a (m−1)th measurement image among the n measurement images and acquires predicted fish position information (PIₘ) in the m-th measurement image on the basis of the fish position information in the at least one selected image, and
on the basis of the fish position information (Iₘ) in the m-th measurement image and the corresponding predicted fish position information (PIₘ), identify the at least one fish in the m-th measurement image as the same fish as in the at least one selected image when the fish position information (Iₘ) matches with the predicted fish position information (PIₘ) and identify the at least one fish in the m-th measurement image as not being the same fish as in the at least one selected image when the fish position information (Iₘ) does not match with the predicted fish position information (PIₘ).

2. The same fish identification device according to claim 1, wherein
the processor is configured to acquire at least one area satisfying a color condition in the n measurement images as the fish position information.

3. The same fish identification device according to claim 1, wherein
the processor is further configured to produce subtracted images that are differences between the respective measurement images and a reference image, and
acquire at least one area satisfying a color change condition in the subtracted images as the fish position information.

4. The same fish identification device according to claim 3, wherein
the reference image is a (m−1)th measurement image, and
the subtracted images are differences between the m-th measurement image and the (m−1)th measurement image, wherein
the processor is configured to acquire at least one area satisfying the color change condition in the subtracted images as the fish position information.

5. The same fish identification device according to claim 1, wherein
the processor is further configured to extract at least one outline in the n measurement images, and
acquire an area enclosed in the at least one outline as the fish position information.

6. The same fish identification device according to claim 1, wherein
the processor is further configured to
remove, from the fish position information, position information satisfying an erroneous detection condition as erroneous information, and
acquire position information obtained after removing the erroneous information as the fish position information.

7. The same fish identification device according to claim 1, wherein
the at least one selected image comprises a plurality of selected images.

8. A fish counting device comprising:
the same fish identification device according to claim 1, and at least one processor,
wherein
the processor is configured to count the at least one fish on the basis of same fish position information on the fish identified as the same fish by the same fish identification device, to obtain a fish count.

9. The fish counting device according to claim 8, wherein
when a distance between fish at both ends of the measurement images indicated by the same fish position information satisfies a length condition, the processor is configured to count the fish.

10. The fish counting device according to claim 8,
when the fish count satisfies a fish count condition, the processor is configured to notify the satisfaction of the fish count condition.

11.-14 (canceled)

15. A same fish identification method for identifying the same fish, comprising:
acquiring, over time, n measurement images of a region to be measured in a passage region where a fluid containing at least one fish passes through,
acquiring fish position information in the n measurement images,
selecting at least one selected image from the measurement images acquired prior to the (m−1)th measurement image among the n measurement images, and acquiring predicted fish position information (PIₘ) in the m-th measurement image on the basis of the fish position information in the at least one selected image, and
on the basis of the fish position information (Iₘ) in the m-th measurement image and the corresponding predicted fish position information (PIₘ), identifying the at least one fish in the m-th measurement image as the same fish as in the at least one selected image when the fish position information (Iₘ) matches with the predicted fish position information (PIₘ) and identifying the at least one fish in the m-th measurement image as not being the same fish as in the at least one selected image when the fish position information (Iₘ) does not match with the predicted fish position information (PIₘ).

16. The same fish identification method according to claim 15, wherein
at least one area satisfying a color condition in the n measurement images is acquired as the fish position information.

17. The same fish identification method according to claim 15, further comprising:
producing subtracted images that are differences between the respective measurement images and a reference image, wherein
at least one area satisfying a color change condition in the subtracted images is acquired as the fish position information.

18. The same fish identification method according to claim 17, wherein
the reference image is a (m−1)th measurement image, and
the subtracted images are differences between the m-th measurement image and the (m−1)th measurement image, wherein
at least one area satisfying a color change condition in the subtracted images is acquired as the fish position information.

19. The same fish identification method according to claim 15, further comprising:
extracting at least one outline in the n measurement images, wherein
an area enclosed in the at least one outline is acquired as the fish position information.

20. The same fish identification method according to claim 15, further comprising:
removing position information satisfying an erroneous detection condition as erroneous information from the fish position information, wherein
position information obtained after removing the erroneous information is acquired as the fish position information.

21. The same fish identification method according to claim 15, wherein
the at least one selected image comprises a plurality of selected images.

22.-31. (canceled)
